(19) United States
(12) Patent Application Publication
(10) Pub. No.: US 2014/0184668 A1
(43) Pub. Date: Jul. 3, 2014

(54) DISPLAY APPARATUS

(71) Applicant: Samsung Display Co., LTD., Yongin-City (KR)

(72) Inventors: Hyun-Deok IM, Seoul (KR); Kwang-Keun LEE, Osan-si (KR); Jae-Byung PARK, Seoul (KR); Hyun-Min CHO, Hwaseong-si (KR); Seon-Tae YOON, Seoul (KR)

(73) Assignee: Samsung Display Co., LTD., Yongin-City (KR)

(21) Appl. No.: 13/893,526

(22) Filed: May 14, 2013

(30) Foreign Application Priority Data
Jan. 3, 2013 (KR) 10-2013-0000485

(51) Int. Cl. G09G 3/36

(52) U.S. Cl. CPC G09G 3/3607
USPC 345/694; 345/88

(57) ABSTRACT

A display apparatus includes a display panel, a panel driving part and a light-source part. The panel driving part provides the display panel with a first sub-frame data during a first sub-frame of an N-th frame (N is a natural number), provides the display panel with a second sub-frame data during a second sub-frame of the N-th frame and providing the display panel with a third sub-frame data during a third sub-frame of the N-th frame, the first sub-frame data including a plurality of data blocks, the data blocks adjacent to each other having color pixel data different from each other, the second sub-frame data including a plurality of data blocks having a color sequence different from the first sub-frame data, and the third sub-frame data including a plurality of data blocks having the color sequence different from the first and second sub-frame data.

This application claims priority to Korean Patent Application No. 10-2013-0000485, filed on Jan. 3, 2013, and all the benefits accruing therefrom under 35 U.S.C. §119, the contents of which in its entirety is herein incorporated by reference.

### BACKGROUND

1. Field

Exemplary embodiments of the invention relate to a display apparatus. More particularly, exemplary embodiments of the invention relate to a display apparatus with improved display quality of a moving image.

2. Description of the Related Art

Generally, a liquid crystal (“LC”) display apparatus includes a back-light unit that emits white light and three color-filters which are spatially divided, and the LC display apparatus may displays multi-color or full-color in a spatial color display mode, which uses colored light transmitted through the three color-filters.

In the spatial color display mode, a unit pixel is typically defined. The unit pixel includes three color sub-pixels having the three color-filters such that the LC display apparatus of the spatial color display mode typically has a resolution decreased by about ⅓ of the total number of the sub-pixels. In the spatial color display mode, optical loss may occur due to the color-filters.

The LC display apparatus may not include the color-filter when the LC display apparatus is driven in a temporal color display mode. In the spatial color display mode, various colors are displayed by mixed color lights transmitted through red, green and blue color sub-pixels. In the temporal color display mode, various colors are displayed by red, green and blue color light sequentially emitted during a frame period. In the temporal color display mode, the optical loss due to the color-filters may be effectively prevented, and the transmittance is thereby increased.

In the temporal color display mode, as red, green and blue images are sequentially displayed, when a moving image is displayed, a color break-up may occur in an edge area of the moving image.

### SUMMARY

Exemplary embodiments of the invention provide a display apparatus with improved display quality.

According to an exemplary embodiment of the invention, a display apparatus includes a display panel, a panel driving part and a light-source part. In such an embodiment, the display panel displays an image and includes a plurality of display blocks. In such an embodiment, the panel driving part provides the display panel with a first sub-frame data during a first sub-frame of an N-th frame (N is a natural number), provides the display panel with a second sub-frame data during a second sub-frame of the N-th frame and providing the display panel with a third sub-frame data during a third sub-frame of the N-th frame, where the first sub-frame data includes a plurality of data blocks, the data blocks adjacent to each other in the first sub-frame data have color pixel data different from each other, the second sub-frame data includes a plurality of data blocks having a color sequence different from a color sequence of the data blocks of the first sub-frame data, and the third sub-frame data includes a plurality of data blocks having the color sequence different from the color sequence of the first sub-frame data and the color sequence of the second sub-frame data. In such an embodiment, the light-source part provides the display blocks with color light corresponding to color pixel data applied to the display blocks.

In an exemplary embodiment, the first sub-frame data may include a first data block having first color pixel data, a second data block having second color pixel data and a third data block having third color pixel data, the second sub-frame data may include a first data block having the second color pixel data, a second data block having the third color pixel data, a third data block having the first color pixel data, the third sub-frame data may include a first data block having the third color pixel data, a second data block having the first color pixel data, a third data block having the second color pixel data, and a mixed color of the first, second and third colors may be white.

In an exemplary embodiment, during the first sub-frame, the light-source part may provide a first display block of the display blocks, which receives the first color pixel data, with a first color light, may provide a second display block of the display blocks, which receives the second color pixel data, with a second color light, and may provide a third display block of the display blocks, which receives the third color pixel data, with a third color light. In such an embodiment, during the second sub-frame, the light-source part may provide the first display block, which receives the second color pixel data, with the second color light, may provide the second display block, which receives the third color pixel data, with the third color light, and may provide the third display block, which receives the first color pixel, data with the first color light. In such an embodiment, during the third sub-frame, the light-source part may provide, the first display block, which receives the third color pixel data, with the third color light, may provide the second display block, which receives the first color pixel data, with the first color light, and may provide the third display block, which receives the second color pixel, data with the second color light.

According to an exemplary embodiment of the invention, a display apparatus includes a display panel, a panel driving part and a light-source part. The display panel displays an image and including a plurality of display blocks. The panel driving part provides the display panel with a first sub-frame data during a first frame of an N-th frame (N is a natural number) and provides the display panel with a second sub-frame data during a second frame of the N-th frame, where the first sub-frame data include a plurality of data blocks, the data blocks adjacent to each other have color pixel data different from each other, and the second sub-frame data include a plurality of data blocks having a color sequence different from a color sequence of the data blocks of the first sub-frame data. The light-source part provides the display blocks with color light corresponding to color pixel data applied to the display blocks.

In an exemplary embodiment, the first sub-frame data may include a first data block having a mixed color pixel data and a second data block having a primary color pixel data, the second sub-frame data may include a first data block having the primary color pixel data and a second data block having the mixed color pixel data, the mixed color is a mixed color of two primary colors of three primary colors, the primary color is the remaining color of the three primary colors, and a mixed color of the three primary colors is white.

In an exemplary embodiment, during the first sub-frame, the light-source part may provide a first display block of the display blocks, which receives the mixed color pixel data, with a mixed color light and may provide a second display block of the display blocks, which receives the primary color pixel data, with a primary color light. In such an embodiment, during the second sub-frame, the light-source part may provide the first display block, which receives the primary color pixel data, with the primary color light and may provide the second display block, which receives the mixed color pixel data, with the mixed color light.

In an exemplary embodiment, during a first sub-frame of an (N+1)-th frame, the panel driving part may provide the display panel with a third sub-frame data including a plurality of data blocks having a color sequence the same as the color sequence of the data blocks of the second sub-frame data. In such an embodiment, during a second of the (N+1)-th frame, the panel driving part may provide the display panel with a fourth sub-frame data including a plurality of data blocks having a color sequence the same as the color sequence of the data blocks of the first sub-frame data.

In an exemplary embodiment, the panel driving part may provide the display panel with black frame data during a third sub-frame of the N-th frame, where the third frame of the N-th frame is between the first sub-frame and the second sub-frame of the N-th frame, and the panel driving part may provide the display panel with the black frame data during a fourth sub-frame of the N-th frame.

In an exemplary embodiment, the first sub-frame data includes a first data block having a first color pixel data and a second data block having black pixel data. In such an embodiment, during the second sub-frame of the N-th frame, the panel driving part may provide the display panel with a second sub-frame data including a first data block having the black pixel data and a second data block having a second color pixel data. In such an embodiment, during a third sub-frame of the N-th frame, the panel driving part may provide the display panel with a third sub-frame data including a first data block having the second color pixel data and a second data block having the black pixel data. In such an embodiment, during a fourth sub-frame of the N-th frame, the panel driving part may provide the display panel with a fourth sub-frame data including a first data block having the black pixel data and a second data block having the first color pixel data.

In an exemplary embodiment, the light-source part may be disposed at a shorter-side of the display panel.

In an exemplary embodiment, the light-source part may be disposed at a longer-side of the display panel.

In an exemplary embodiment, the light-source part may be disposed under the display panel.

According to an exemplary embodiment of the invention, a display apparatus includes a display panel, a panel driving part and a light-source part. The display panel displays an image. In such an embodiment, the panel driving part displays a sub-frame data including M×M pixel data (M is a natural number) which are repetitively arranged, the M×M pixel data of the sub-frame have a color sequence different from a color sequence of the M×M pixel data of next sub-frame data. In such an embodiment, the light-source part provides the display panel with color light corresponding to colors of pixel data applied to the display panel.

In an exemplary embodiment, a pixel data of the M×M pixel data is black pixel data.

In an exemplary embodiment, the sub-frame data may include 3×3 pixel data which are repetitively arranged.

In an exemplary embodiment, the panel driving part may provide the display panel with a first sub-frame data including 3×3 pixel data during a first sub-frame of a frame period, where three pixel data of the 3×3 pixel data of the first sub-frame data are first color pixel data and arranged in a first diagonal direction with respect to a 3×3 structure, and remaining six pixel data of the 3×3 pixel data of the first sub-frame data are black pixel data. In such an embodiment, the panel driving part may provide the display panel with a second sub-frame data including 3×3 pixel data during a second sub-frame of the frame period, where three pixel data of the 3×3 pixel data of the second sub-frame data are the black pixel data and arranged in a second diagonal direction crossing the first diagonal direction with respect to the 3×3 structure, and remaining six pixel data of the 3×3 pixel data of the second sub-frame data are second color pixel data. In such an embodiment, the panel driving part may provide the display panel with a third sub-frame data including 3×3 pixel data during a third sub-frame of the frame period, where the 3×3 pixel data of the third sub-frame data are third color pixel data. In such an embodiment, the panel driving part may provide the display panel with a fourth sub-frame data including 3×3 pixel data during a fourth sub-frame of the frame period, where three pixel data of the 3×3 pixel data of the fourth sub-frame data are the black pixel data and arranged in the first diagonal direction with respect to the 3×3 structure, and remaining six pixel data of the 3×3 pixel data of the fourth sub-frame data are the first color pixel data. In such an embodiment, the panel driving part may provide the display panel with fifth sub-frame data including 3×3 pixel data during a fifth sub-frame of the frame period, where three pixel data of the 3×3 pixel data of the fifth sub-frame data are the second color pixel data and arranged in the second diagonal direction with respect to the 3×3 structure, and remaining six pixel data of the 3×3 pixel data of the fifth sub-frame data are the black pixel data.

In an exemplary embodiment, the light-source part may provide the display panel with a first color light during the first sub-frame, provide the display panel with a second color light during the second sub-frame, provide the display panel with a third color light during the third sub-frame, provide the display panel with the first color light during the fourth sub-frame, and provide the display panel with the second color light during the fourth sub-frame.

In an exemplary embodiment, the sub-frame data may include 2×2 pixel data, which are repetitively arranged.

In an exemplary embodiment, the panel driving part may provide the display panel with a first sub-frame data including 2×2 pixel data during a first sub-frame of a frame period, where two pixel data of the 2×2 pixel data of the first sub-frame data are first color pixel data and arranged in a first diagonal direction with respect to a 2×2 structure, and remaining two pixel data of the 2×2 pixel data of the first sub-frame data are black pixel data. In such an embodiment, the panel driving part may provide the display panel with a second sub-frame data including 2×2 pixel data during a second sub-frame of the frame period, where the 2×2 pixel data of the second sub-frame data are second color pixel data. In such an embodiment, the panel driving part may provide the display panel with a third sub-frame data including 2×2 pixel data during a third sub-frame of the frame period, where two pixel data of the 2×2 pixel data of the third sub-frame data are the first color pixel data and arranged in a second diagonal direction crossing the first diagonal direction with respect to the 2×2 structure, and remaining two pixel data of the 2×2 pixel data of the third sub-frame data are the black pixel data.

In an exemplary embodiment, the light-source part may provide the display panel with a first color light during the second sub-frame, and provide the display panel with a second color light during the second sub-frame, wherein the first color may be a mixed color of two primary colors of three primary colors and the second color may be the remaining primary color of the three primary colors.

According to the invention, image blocks adjacent to each other have colors different from each other, and each of the image blocks in a sub-frame has the color different from the corresponded image block of next sub-frame. In such an embodiment, pixels adjacent to each other have color pixel data different from each other, and each of the pixels in a sub-frame has the color pixel data different from the corresponded pixel of next sub-frame. In such an embodiment, the color break-up and a flicker caused by luminance difference between different colors different from each other are substantially reduced.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating an exemplary embodiment of a display apparatus according to the invention;

FIG. 2 is a conceptual diagram illustrating an exemplary embodiment of a method of driving a data processing part shown in FIG. 1;

FIG. 3 is a signal timing diagram illustrating an exemplary embodiment of a method of displaying an image in the display apparatus shown in FIG. 1;

FIGS. 4A and 4B are conceptual diagrams illustrating a moving image displayed by the method shown in FIG. 3;

FIG. 5 is a conceptual diagram illustrating an alternative exemplary embodiment of a method of driving a data processing part according to the invention;

FIG. 6 is a conceptual diagram illustrating an exemplary embodiment of a method of displaying an image based on the method as shown in FIG. 5;

FIG. 7 is a block diagram illustrating an alternative exemplary embodiment of a display apparatus according to the invention;

FIG. 8 is a conceptual diagram illustrating an exemplary embodiment of a method of driving a data processing part shown in FIG. 7;

FIG. 9 is a signal timing diagram illustrating an exemplary embodiment of a method of displaying an image in the display apparatus shown in FIG. 7;

FIGS. 10A and 10B are conceptual diagrams illustrating a moving image displayed by the method shown in FIG. 9;

FIG. 11 is a conceptual diagram illustrating an alternative exemplary embodiment of a method of driving a data processing part according to the invention;

FIGS. 12A and 12B are conceptual diagrams illustrating a moving image displayed by the method as shown in FIG. 11;

FIG. 13 is a conceptual diagram illustrating another alternative exemplary embodiment of a method of driving a data processing part according to the invention;

FIGS. 14A and 14B are conceptual diagrams illustrating a moving image displayed by the method as shown in FIG. 13;

FIG. 15 is a conceptual diagram illustrating another alternative exemplary embodiment of a method of driving a data processing part according to the invention;

FIG. 16 is a conceptual diagram illustrating another alternative exemplary embodiment of a method of driving a data processing part according to the invention;

FIG. 17 is a conceptual diagram illustrating an exemplary embodiment of a method of displaying an image using the method shown in FIG. 16;

FIG. 18 is a conceptual diagram illustrating an exemplary embodiment of a light-source part of a display apparatus according to the invention;

FIG. 19 is a conceptual diagram illustrating an exemplary embodiment of a method of driving the display apparatus shown in FIG. 18;

FIG. 20 is a conceptual diagram illustrating an alternative exemplary embodiment of a light-source part of a display apparatus according to the invention; and

FIG. 21 is a conceptual diagram illustrating an exemplary embodiment of a method of driving the display apparatus shown in FIG. 20.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in detail with reference to the accompanying drawings.

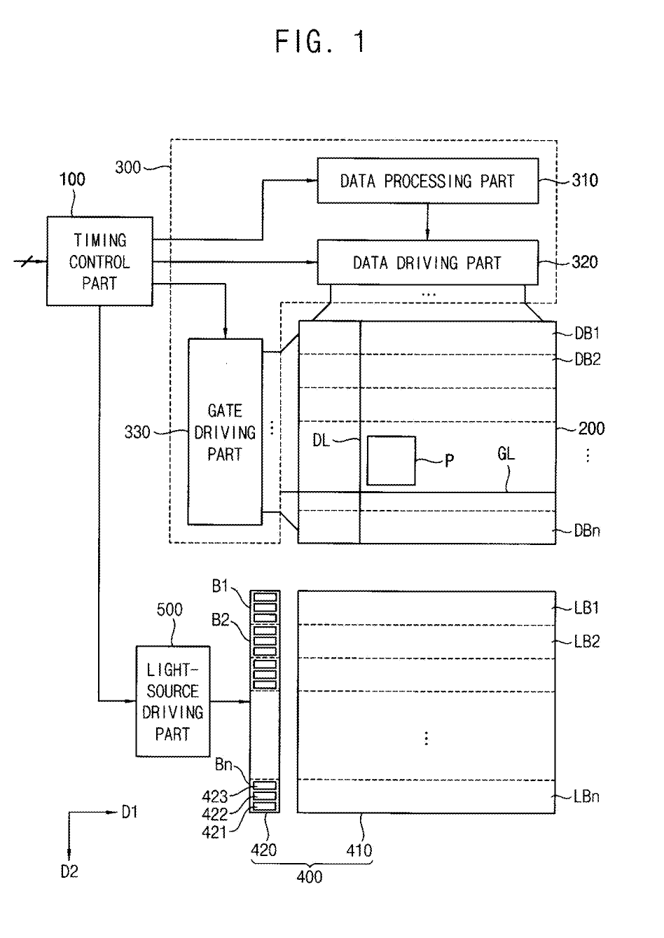

FIG. 1 is a block diagram illustrating an exemplary embodiment of a display apparatus according to the invention.

Referring to FIG. 1, the display apparatus may include a timing control part 100, a display panel 200, a panel driving part 300, a light-source part 400 and a light-source driving part 500.

The timing control part 100 generates timing control signals using horizontal and vertical synchronization signals, and drives the display panel 200 and the light-source part 400 using the timing control signals.

The display panel 200 may include a plurality of gate lines GL, a plurality of data lines DL and a plurality of pixels P. The gate lines GL extend substantially in a first direction D1 and arranged substantially in a second direction D2 crossing the first direction D1. The data lines DL extend substantially in the second direction D2 and arranged substantially in the first direction D1. In an exemplary embodiment, each of the pixels P does not include a color-filter and may have a square shape.

The panel driving part 300 may include a data processing part 310, a data driving part 320 and a gate driving part 330.

The data processing part 310 generates first sub-frame data, second sub-frame data and third sub-frame data using frame data including red, green and blue data based on a temporal color display mode. According to an exemplary embodiment, each sub-frame data include a plurality of data blocks. The data blocks adjacent to each other in the sub-frame data have color pixel data different from each other. Each of the data blocks in the sub-frame data have color pixel data different from the color pixel data thereof in a next sub-frame data.

The data driving part 320 converts the color pixel data received from the data processing part 310 into a data voltage and outputs the data voltage to the data lines DL. The data blocks in the sub-frame data are provided to a plurality of display blocks DB1, DB2, . . . , DBn of the display panel 200, where n is a natural number. The display blocks DB1, DB2, . . . , DBn respectively correspond to a plurality of light-emitting blocks LB1, LB2, . . . , LBn of the light-source part 400.

The gate driving part 330 generates a plurality of gate signals, and sequentially outputs the gate signals to the gate lines GL in synchronization with output timing of the data driving part 320.

The light-source part 400 includes a light guide plate (“LGP”) 410 and a light-source unit 420. The light-source unit 420 includes a plurality of color light-sources, and is disposed near a short-side of the LGP 410. In an exemplary embodiment, the light-source unit 420 may be disposed along the short-side of the LGP 410. The light-source unit 420 includes a plurality of light-source blocks B1, B2, . . . , Bn, and each of the light-source blocks B1, B2, . . . , Bn includes a plurality of color light-sources 421, 422 and 423, which emits light of different colors. The color light-sources 421, 422 and 423 include a first color light-source 421 that emits first color light, a second color light-source 422 that emits second color light and a third color light-source 423 that emits third color light. A mixed color light by mixing the first, second and third color lights, is white light. According to an exemplary embodiment, first, second and third colors may be red, green and blue, but not being limited thereto. According to an exemplary embodiment, the first color light-source 421 is a red light-source 421, the second color light-source 422 is a green light-source 422, and the third color light-source 423 is a blue light-source 423.

The light-source part 400 is divided into the light-emitting blocks LB1, LB2, . . . , LBn corresponding to the light-source blocks B1, B2, . . . , Bn.

The light-source driving part 500 sequentially drives the light-source blocks B1, B2, . . . , Bn during a sub-frame of a frame period. The light-source driving part 500 drives the red, green and blue light-sources 421, 422 and 423 in each of the light-source blocks B1, B2, . . . , Bn, to emit color light corresponding to the color pixel data applied to a display block of display panel 200, based on a control of the timing control part 100.

In one exemplary embodiment, for example, when red pixel data of a first data block are applied to a first display block DB1 of the display panel 200 during a first sub-frame of the frame, a first light-emitting block LB1 of the light-source part 400 emits the red light corresponding to the red pixel data applied to the display block DB1. In such an embodiment, as described above, the light-emitting block of the light-source part 400 emits the color light corresponding to the color pixel data applied to the display block of the display panel 200.

According to an exemplary embodiment, the display apparatus may display a first sub-frame image including color image blocks during the first sub-frame, display a second sub-frame image including color image blocks arranged different from the color image blocks of the first sub-frame image during the second sub-frame, and display a third sub-frame image including color image blocks arranged different from the color image blocks of the second sub-frame image during the third sub-frame.

In such an embodiment, the image blocks adjacent to each other have colors different from each other, and each of the image blocks has the color different from the color thereof in the next sub-frame. In such an embodiment, where the display apparatus operates in the temporal color display mode, the color break-up is substantially improved, and a flicker caused by luminance difference between different colors different from each other is substantially improved.

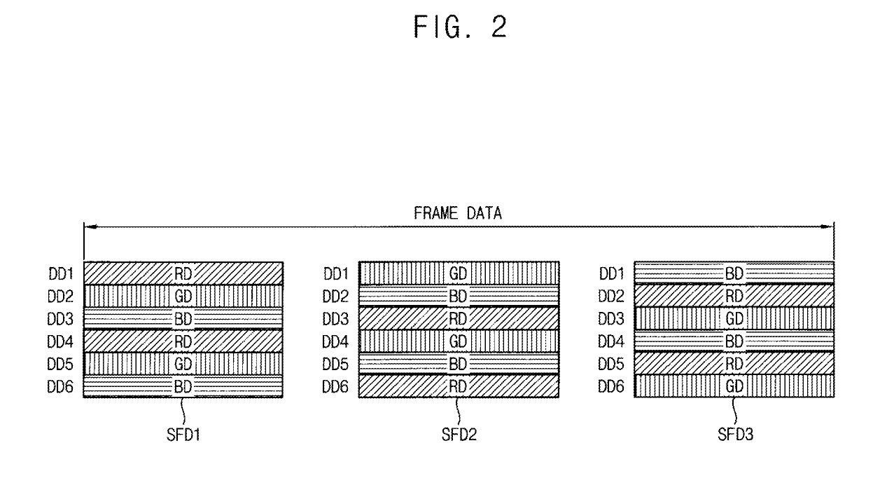

FIG. 2 is a conceptual diagram illustrating an exemplary embodiment of a method of driving a data processing part shown in FIG. 1.

Referring to FIGS. 1 and 2, in an exemplary embodiment, the display panel 200 and the light-source part 400 may be driven at a driving frequency of about 180 hertz (Hz). Hereinafter, for convenience of description, an exemplary embodiment, where each of the display panel 200 and the light-source part 400 are divided into a plurality of blocks, and the number of the blocks is six, will be described in detail.

The data processing part 310 generates a plurality of sub-frame data using the frame data. The frame data include red, green and blue data. The sub-frame data include first sub-frame data SFD1, second sub-frame data SFD2 and third sub-frame data SFD3, and each of the first, second and third sub-frame data SFD1, SFD2 and SFD3 include red pixel data, green pixel data and blue pixel data.

The first sub-frame data SFD1 include a first data block DD1 having the red pixel data RD, a second data block DD2 having the green pixel data GD, a third data block DD3 having the blue pixel data BD, a fourth data block DD4 having the red pixel data RD, a fifth data block DD5 having the green pixel data GD and a sixth data block DD6 having the blue pixel data BD.

The second sub-frame data SFD2 include the first data block DD1 having the green pixel data GD, the second data block DD2 having the blue pixel data BD, the third data block DD3 having the red pixel data RD, the fourth data block DD4 having the green pixel data GD, the fifth data block DD5 having the blue pixel data BD and the sixth data block DD6 having the red pixel data RD.

The third sub-frame data SFD3 include the first data block DD 1 having the blue pixel data BD, the second data block DD2 having the red pixel data RD, the third data block DD3 having the green pixel data GD, the fourth data block DD4 having the blue pixel data BD, the fifth data block DD5 having the red pixel data RD and the sixth data block DD6 having the green pixel data GD.

In an exemplary embodiment, as described above, the data processing part 310 generates a plurality of sub-frame data, each of the sub-frame data include the data blocks adjacent to each other having color pixel data different from each other (e.g., pixel data of different colors), and each of the data blocks in the sub-frame data has the color pixel data different from the color pixel data thereof in the next sub-frame data.

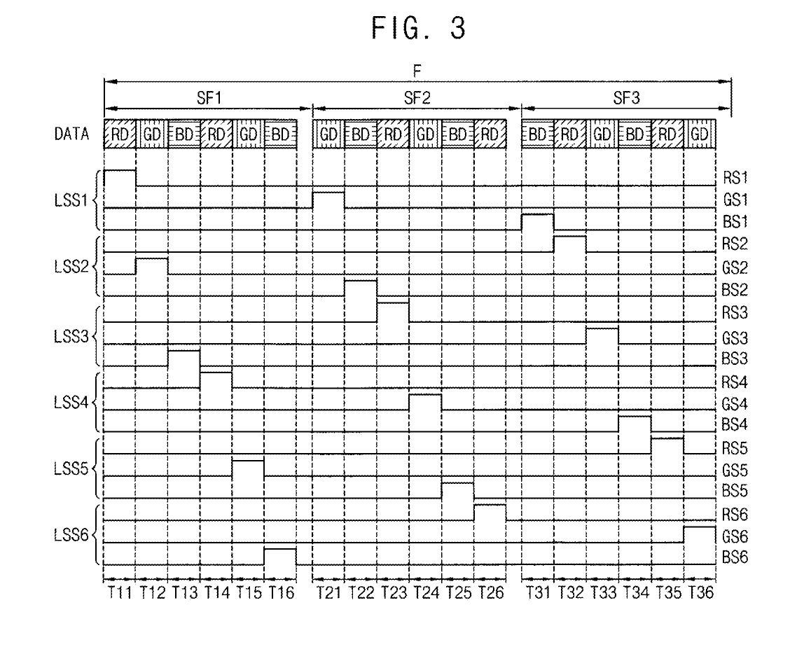

FIG. 3 is a signal timing diagram illustrating an exemplary embodiment of a method of displaying an image in the display apparatus shown in FIG. 1.

Referring to FIGS. 1, 2 and 3, the data driving part 320 provides the display panel 200 with the sub-frame data processed from the data processing part 310.

During the first sub-frame SF1 of the frame period F, the data driving part 320 provides the display panel 200 with the first sub-frame data SFD1. The light-source driving part 500 provides the first to sixth light-source blocks B1, B2, B3, B4, B5 and B6 with first to sixth light-source driving signals LSS1, LSS2, LSS3, LSS4, LSS5 and LSS6 in synchronization with the first sub-frame data SFD1. Each of the first to sixth light-source driving signals includes red, green and blue driving signals RS1 to RS6, GS1 to GS6, and BS1 to BS6, which are applied to the red, green and blue light-sources 421, 422 and 423.

In one exemplary embodiment, for example, during a first period T11 of the first sub-frame SF1, during which the red pixel data RD in the first data block DD1 of the first sub-frame data SFD1 are applied to a first display block DB1, the red light-source 421 of the first light-source block B1 turns on the light such that the first light-emitting block LB1 emits the red light (RS1). During the first period T11 of the first sub-frame SF1, the green and blue light-sources 422 and 423 of the first light-source block B1 turn off the light (GS1 and BS1).

During a second period T12 of the first sub-frame SF1, during which the green pixel data GD in the second data block DD2 of the first sub-frame data SFD1 are applied to a second display block DB2, the green light-source 422 of the second light-source block B2 turns on the light such that the second light-emitting block LB2 emits the green light (GS2). During the second period T12 of the first sub-frame SF1, the red and blue light-sources 421 and 423 of the second light-source block B2 turn off the light (RS2 and BS2).

During a third period T13 of the first sub-frame SF1, during which the blue pixel data BD in the third data block DD3 of the first sub-frame data SFD1 are applied to a third display block DB3, the blue light-source 423 of the third light-source block B3 turns on the light such that the third light-emitting block LB3 emits the blue light (BS3). During the third period T13 of the first sub-frame SF1, the red and blue light-sources 421 and 423 of the third light-source block B3 turn off the light (RS3 and BS3).

During a fourth period T14 of the first sub-frame SF1, during which the red pixel data RD in the fourth data block DD4 of the first sub-frame data SFD1 are applied to a fourth display block DB4, the red light-source 421 of the fourth light-source block B4 turns on the light such that the fourth light-emitting block LB4 emits the red light (RS4). During the fourth period T14 of the first sub-frame SF1, the green and blue light-sources 422 and 423 of the fourth light-source block B4 turn off the light (GS4 and BS4).

During a fifth period T15 of the first sub-frame SF1, during which the green pixel data GD in the fifth data block DD5 of the first sub-frame data SFD1 are applied to a fifth display block DB5, the green light-source 422 of the fifth light-source block B5 turns on the light such that the fifth light-emitting block LB5 emits the green light (GS5). During the fifth period T15 of the first sub-frame SF1, the red and blue light-sources 421 and 423 of the fifth light-source block B5 turn off the light (RS5 and BS5).

During a sixth period T16 of the first sub-frame SF1, during which the blue pixel data BD in the sixth data block DD6 of the first sub-frame data SFD1 are applied to a sixth display block DB6, the blue light-source 423 of the sixth light-source block B6 turns on the light so that the sixth light-emitting block LB6 emits the blue light (BS6). During the sixth period T16 of the first sub-frame SF1, the red and green light-sources 421 and 422 of the sixth light-source block turn off the light (RS6 and GS6).

During a second sub-frame SF2 of the frame period F, the data driving part 320 provides the display panel 200 with the second sub-frame data SFD2. The light-source driving part 500 provides the first to sixth light-source blocks B1, B2, B3, B4, B5 and B6 with first to sixth light-source driving signals LSS1, LSS2, LSS3, LSS4, LSS5 and LSS6 in synchronization with second sub-frame data SFD2.

In one exemplary embodiment, for example, during a first period T21 of the second sub-frame SF2, during which the green pixel data GD in the first data block DD1 of the second sub-frame data SFD2 are applied to the first display block DB1, the green light-source 422 of the first light-source block B1 turns on the light such that the first light-emitting block LB1 emits the green light (GS1). During the first period T21 of the second sub-frame SF2, the red and blue light-sources 421 and 423 of the first light-source block B1 turn off the light (RS1 and BS1).

During a second period T22 of the second sub-frame SF2, during which the blue pixel data BD in the second data block DD2 of the second sub-frame data SFD2 are applied to the second display block DB2, the blue light-source 423 of the second light-source block B2 turns on the light such that the second light-emitting block LB2 emits the blue light (BS2). During the second period T22 of the second sub-frame SF2, the red and green light-sources 421 and 422 of the second light-source block B2 turn off the light (RS2 and GS2).

During a third period T23 of the second sub-frame SF2, during which the red pixel data RD in the third data block DD3 of the second sub-frame data SFD2 are applied to the third display block DB3, the red light-source 421 of the third light-source block B3 turns on the light such that the third light-emitting block LB3 emits the red light (RS3). During the third period T23 of the second sub-frame SF2, the green and blue light-sources 422 and 423 of the third light-source block B3 turn off the light (GS3 and BS3).

During a fourth period T24 of the second sub-frame SF2, during which the green pixel data GD in the fourth data block DD4 of the second sub-frame data SFD2 are applied to the fourth display block DB4, the green light-source 422 of the fourth light-source block B4 turns on the light such that the fourth light-emitting block LB4 emits the green light (GS4). During the fourth period T24 of the second sub-frame SF2, the red and blue light-sources 421 and 423 of the fourth light-source block B4 turn off the light (RS4 and BS4).

During a fifth period T25 of the second sub-frame SF2, during which the blue pixel data BD in the fifth data block DD5 of the second sub-frame data SFD2 are applied to the fifth display block DB5, the blue light-source 423 of the fifth light-source block B5 turns on the light such that the fifth light-emitting block LB5 emits the blue light (BS5). During the fifth period T25 of the second sub-frame SF2, the red and green light-sources 421 and 422 of the fifth light-source block B5 turn off the light (RS5 and GS5).

During a sixth period T26 of the second sub-frame SF2, during which the red pixel data RD in the sixth data block DD6 of the second sub-frame data SFD2 are applied to the sixth display block DB6, the red light-source 421 of the sixth light-source block B6 turns on the light such that the sixth light-emitting block LB6 emits the red light (RS6). During the sixth period T26 of the second sub-frame SF2, the green and blue light-sources 422 and 423 of the sixth light-source block B6 turn off the light (GS6 and BS6).

During a third sub-frame SF3 of the frame period F, the data driving part 320 provides the display panel 200 with the third sub-frame data SFD3. The light-source driving part 500 provides the first to sixth light-source blocks B1, B2, B3, B4, B5 and B6 with first to sixth light-source driving signals LSS1, LSS2, LSS3, LSS4, LSS4, LSS5 and LSS6 in synchronization with third sub-frame data SFD3.

In one exemplary embodiment, for example, during a first period T31 of the third sub-frame SF3, during which the blue pixel data BD in the first data block DD1 of the third sub-frame data SFD3 are applied to the first display block DB1, the blue light-source 423 of the first light-source block B1 turns on the light such that the first light-emitting block LB1 emits the blue light (BS1). During the first period T31 of the third sub-frame SF3, the red and green light-sources 421 and 422 of the first light-source block B1 turn off the light (RS1 and GS1).

During a second period T32 of the third sub-frame SF3, during which the red pixel data RD in the second data block DD2 of the third sub-frame data SFD3 are applied to the second display block DB2, the red light-source 421 of the second light-source block B2 turns on the light such that the second light-emitting block LB2 emits the red light (RS2). During the second period T32 of the third sub-frame SF3, the green and blue light-sources 422 and 423 of the second light-source block B2 turn off the light (GS2 and BS2).

During a third period T33 of the third sub-frame SF3, during which the green pixel data GD in the third data block DD3 of the third sub-frame data SFD3 are applied to the third display block DB3, the green light-source 422 of the third light-source block B3 turns on the light such that the third light-emitting block LB3 emits the green light (GS3). During the third period T33 of the third sub-frame SF3, the red and blue light-sources 421 and 423 of the third light-source block B3 turn off the light (RS3 and BS3).

During a fourth period T34 of the third sub-frame SF3, during which the blue pixel data BD in the fourth data block DD4 of the third sub-frame data SFD3 are applied to the fourth display block DB4, the blue light-source 423 of the fourth light-source block B4 turns on the light such that the fourth light-emitting block LB4 emits the blue light (BS4). During the fourth period T34 of the third sub-frame SF3, the red and green light-sources 421 and 422 of the fourth light-source block B4 turn off the light (RS4 and GS4).

During a fifth period T35 of the third sub-frame SF3, during which the red pixel data RD in the fifth data block DD5 of the third sub-frame data SFD3 are applied to the fifth display block DB5, the red light-source 421 of the fifth light-source block B5 turns on the light such that the fifth light-emitting block LB5 emits the red light (RS5). During the fifth period T35 of the third sub-frame SF3, the green and blue light-sources 422 and 423 of the fifth light-source block B5 turn off the light (GS5 and BS5).

During a sixth period T36 of the third sub-frame SF3, during which the green pixel data GD in the sixth data block DD6 of the third sub-frame data SFD3 are applied to the sixth display block DB6, the green light-source 422 of the sixth light-source block B6 turns on the light such that the sixth light-emitting block LB6 emits the green light (GS6). During the sixth period T36 of the third sub-frame SF3, the red and blue light-sources 421 and 423 of the sixth light-source block B6 turn off the light (RS6 and BS6).

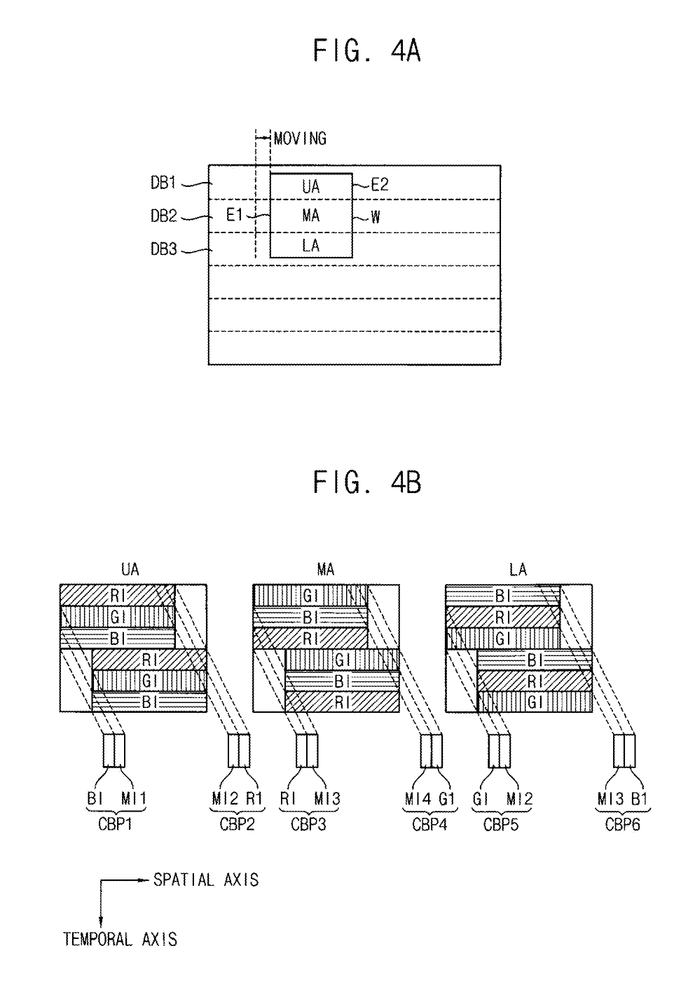

FIGS. 4A and 4B are conceptual diagrams illustrating a moving image displayed by the method as shown in FIG. 3.

Referring to FIGS. 2, 4A and 4B, according to an exemplary embodiment, the display apparatus sequentially displays red image, green image and blue image to display a white image. In such an embodiment, a color sequence of the color image displayed on the display block is different every display block.

As shown in FIG. 4A, in an exemplary embodiment, a white box W may be displayed on the first, second and third display blocks DB1, DB2 and DB3.

The first display block DB1 sequentially displays the red image R1, the green image GI and the blue image BI, and repetitively displays the red image R1, the green image GI and the blue image BI every frame. The first display block DB1 displays an upper area UA of the white box W. The second display block DB2 sequentially displays the green image GI, the blue image BI and the red image R1, and repetitively displays the green image GI, the blue image BI and the red image R1 every frame. The second display block DB2 displays a middle area MA of the white box W. The third display block DB3 sequentially displays the blue image BI, the red image RI and green image GI, and repetitively displays the blue image BI, the red image RI and green image GI every frame. The third display block DB3 displays a lower area LA of the white box W.

In an exemplary embodiment, the color images, e.g., the red image RI, the green image GI and the blue image BI, are displayed based on a time division mode. In such an embodiment, when the white box W moves along a temporal axis, a color breaking pattern may be displayed at an edge area of the white box W.

Referring to FIG. 4B, a first color breaking pattern CBP1, which includes a first mixing image MI1 by mixing the green image GI and the blue image BI, and the blue image BI, may be observed at a first edge area E1 of the upper area UA. A second color breaking pattern CBP2, which includes a second mixing image MI2 by mixing the red image RI and the green image GI, and the red image RI, may be observed at a second edge area E2 of the upper area UA.

A third color breaking pattern CBP3, which includes a third mixing image MI3 by mixing the red image RI and the blue image BI, and the red image RI, may be observed at the first edge area E1 of the middle area MA. A fourth color breaking pattern CBP4, which includes a fourth mixing image MI4 by mixing the green image GI and the blue image BI, and the green image GI, may be observed at the second edge area E2 of the middle area MA.

A fifth color breaking pattern CBP5, which includes the second mixing image MI2 by mixing the green image GI and the red image RI, and the green image GI, may be observed at the first edge area E1 of the lower area LA. A sixth color breaking pattern CBP, which includes the third mixing image MI3 by mixing the blue image BI and the red image RI, and the blue image BI, may be observed at the second edge area E2 of the lower area LA.

As described above, according to an exemplary embodiment, various color breaking patterns CBP1 to CBP6 may be observed at the edge areas of the white box W. In such an embodiment, an achromatic color may be observed by mixing the color breaking patterns CBP1 to CBP6 such that the color break-up observed at the edge areas of the moving image is substantially reduced.

According to an exemplary embodiment, when the number of the divided blocks of the display panel 200 and the light-source part 400 is increased, the number of the color breaking pattern divided in the second direction D2 may be increased.

In such an embodiment, when a driving frequency of the display panel 200 and the light-source part 400 is increased, a width of the color breaking pattern in the first direction D1 may be decreased. In one exemplary embodiment, for example, the driving frequency of the display panel 200 and the light-source part 400 is about 180 Hz. In an exemplary embodiment, when the driving frequency of the display panel 200 and the light-source part 400 is about 360 Hz, the width of the color breaking pattern in the first direction D1 may be decreased by about ½ with respect to the width of the color breaking pattern as shown in FIG. 4B.

In an exemplary embodiment, as described above, when the number of the divided blocks of the display panel 200 and the light-source part 400 is increase and the driving frequency of the display panel 200 and the light-source part 400 is increased, the number of the color breaking pattern may be increased and the width of the color breaking pattern may be decreased. In such an embodiment, the color break-up observed at the edge areas of the moving image may be further reduced by increasing the number of the divided blocks or the driving frequency of the display panel 200 and the light-source part 400.

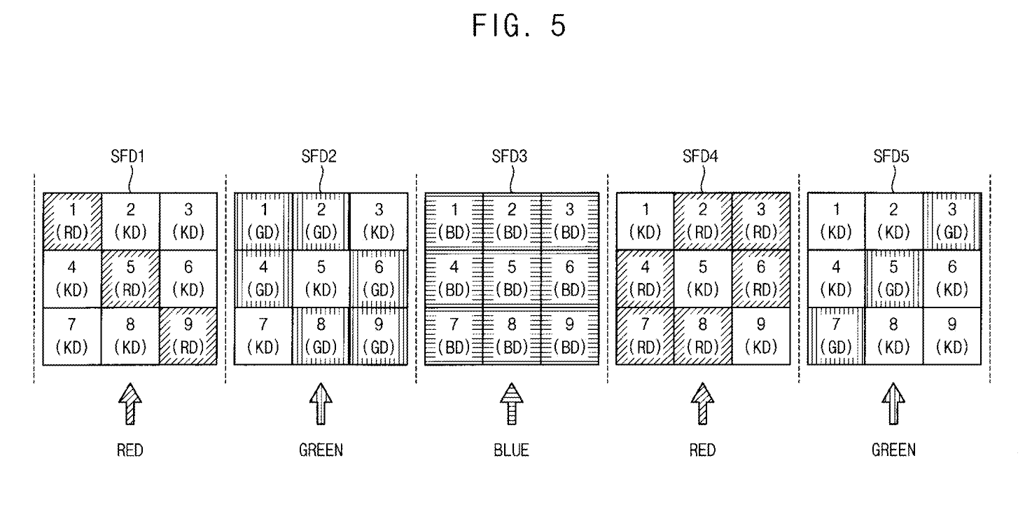

FIG. 5 is a conceptual diagram illustrating an alternative exemplary embodiment of a method of driving a data processing part according to the invention.

Referring to FIGS. 1 and 5, according to an exemplary embodiment, the display panel 200 and the light-source part 400 may be driven at the driving frequency of about 300 Hz.

According to an exemplary embodiment, as shown in FIG. 5, the data processing part 310 generates five sub-frame data during a frame period. The sub-frame data include 3×3 pixel data corresponding to a 3×3 pixel structure, which are repetitively arranged in the first direction D1 and the second direction D2 shown in FIG. 1. In the 3×3 pixel structure, first, second and third pixels 1, 2 and 3 are sequentially arranged in the first direction D1. In the 3×3 pixel structure, fourth, fifth and sixth pixels 4, 5 and 6 are sequentially arranged in the first direction D1, and respectively disposed adjacent to the first, second and third pixels 1, 2 and 3 in the second direction D2. In the 3×3 pixel structure, seventh, eighth and ninth pixels 7, 8 and 9 are sequentially arranged in the first direction D1, and respectively disposed adjacent to the fourth, fifth and sixth pixels 4, 5 and 6 in the second direction D2.

As shown in FIG. 5, the data processing part 310 generates first sub-frame data SFD1, second sub-frame data SFD2, third sub-frame data SFD3, fourth sub-frame data SFD4 and fifth sub-frame data SFD5 using frame data. Pixel data adjacent to each other in each of the first to fifth sub-frame data SFD1 to SFD5 have a color sequence different from each other. In one exemplary embodiment, for example, the first pixel data corresponding to a first pixel 1 have the color sequence of the red, green, blue, black and black with respect to the first to fifth sub-frame data SFD1 to SFD5. In such an embodiment, the second pixel data corresponding to a second pixel 2 adjacent to the first pixel 1 may have the color sequence of black, green, blue, red and black with respect to the first to fifth sub-frame data SFD1 to SFD5.

The first sub-frame data SFD1 include red pixel data RD corresponding to the first, fifth and ninth pixels 1, 5 and 9 arranged in a first diagonal direction and black pixel data KD corresponding to remaining second, third, fourth, sixth, seventh and eighth pixels 2, 3, 4, 6, 7 and 8.

The second sub-frame data SFD2 include the black pixel data KD corresponding to the third, fifth and seventh pixels 3, 5 and 7 in a second diagonal direction crossing the first diagonal direction and green pixel data GD corresponding to remaining first, second, fourth, sixth, eighth and ninth pixels 1, 2, 4, 6, 8 and 9.

The third sub-frame data SFD3 include blue pixel data BD corresponding to the first, second, third, fourth, fifth, sixth, seventh, eighth and ninth pixels 1, 2, 3, 4, 5, 6, 7, 8 and 9.

The fourth sub-frame data SFD4 include the black pixel data KD corresponding to the first, fifth and ninth pixels 1, 5 and 9 arranged in the first diagonal direction and the red pixel data RD corresponding to remaining second, third, fourth, sixth, seventh and eighth pixels 2, 3, 4, 6, 7 and 8.

The fifth sub-frame data SFD5 include the green pixel data GD corresponding to the third, fifth and seventh pixels 3, 5 and 7 arranged in the second diagonal direction and the black pixel data KD corresponding to remaining first, second, fourth, sixth, eighth and ninth pixels 1, 2, 4, 6, 8 and 9.

According to an exemplary embodiment, the light-source driving part 500 drives the light-source part 400 to emit the color light based on the sub-frame data applied to the display panel 200 during the sub-frame.

In one exemplary embodiment, for example, during a first sub-frame, during which the first sub-frame data SFD1 including the red pixel data RD are applied to the display panel 200, the light-source part 400 emits the red light. During a second sub-frame, during which the second sub-frame data SFD2 including the green pixel data GD are applied to the display panel 200, the light-source part 400 emits the green light. During a third sub-frame, during which the third sub-frame data SFD3 including the blue pixel data BD are applied to the display panel 200, the light-source part 400 emits the blue light. During a fourth sub-frame, during which the third sub-frame data SFD3 including the red pixel data RD are applied to the display panel 200, the light-source part 400 emits the red light. During a fifth sub-frame, during which the fifth sub-frame data SFD5 including the green pixel data GD are applied to the display panel 200, the light-source part 400 emits the green light.

According to an exemplary embodiment, the light-source part 400 may be driven in a scanning mode, in which the light-source blocks are sequentially turned on or off as in the exemplary embodiment shown in FIG. 3. In an alternative exemplary embodiment, the light-source part 400 may be driven in a blinking mode, in which all of the light-source blocks of the light-source part 400 are simultaneously turns on or off.

According to an exemplary embodiment, the pixels adjacent to each other may have color pixel data different from each other, and each of the pixels has the color pixel data different from the color pixel data thereof in the next sub-frame. In an exemplary embodiment, where the display apparatus operates in the temporal color display mode, the color break-up is substantially improved, and a flicker caused by luminance difference between different colors is substantially improved.

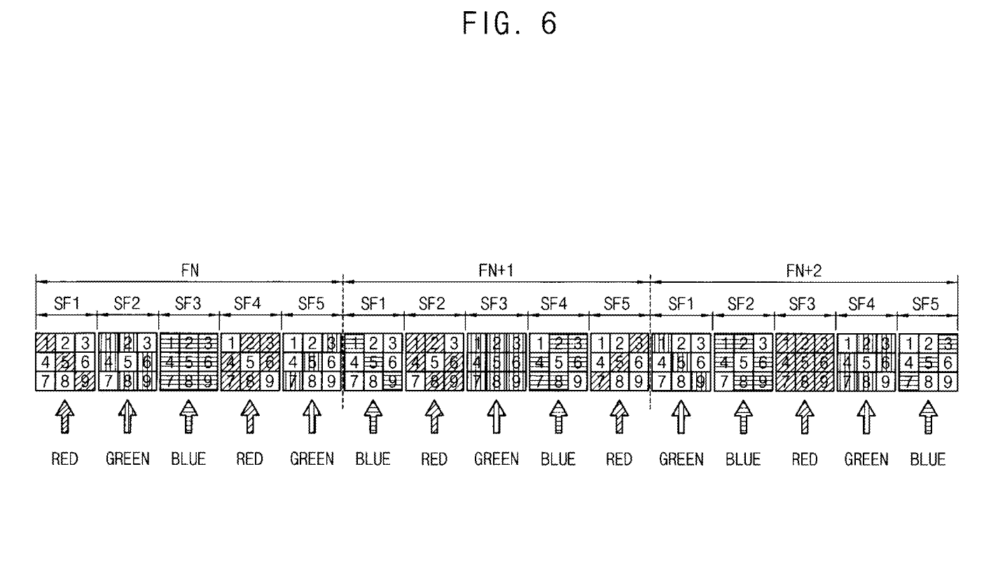

FIG. 6 is a conceptual diagram illustrating an exemplary embodiment of a method of displaying an image based on the method shown in FIG. 5.

Referring to FIGS. 1, 5 and 6, according to an exemplary embodiment, a frame period is divided into five sub-frames. In such an embodiment, a display panel sequentially displays five color images to display a white image during the frame period. In such an embodiment, a light-source part emits the color light corresponding to the color image displayed on the display panel in each sub-frame, and repetitively emits the same color light every three sub-frames.

In an exemplary embodiment, the data processing part 310 generates first to fifth sub-frame data using N-th frame data.

First sub-frame data of an N-th frame FN include the red pixel data corresponding to first, fifth and ninth pixels 1, 5 and 9 and black pixel data corresponding to the second, third, fourth, sixth, seventh and eighth pixels 2, 3, 4, 6, 7 and 8. The light-source part 400 emits the red light during a first sub-frame SF1 of the N-th frame FN, during which the first sub-frame data are applied to the display panel 200. Thus, during the first sub-frame SF1 of the N-th frame FN, a red image is displayed on the display panel 200 by the data processing part 310 and the light-source part 400.

Second sub-frame data of the N-th frame FN include the green pixel data corresponding to the first, second, fourth, sixth, eighth and ninth pixels 1, 2, 4, 6, 8 and 9, and the black pixel data corresponding to the third, fifth and seventh pixels 3, 5 and 7. The light-source part 400 emits the green light during a second sub-frame SF2 of the N-th frame FN, during which the second sub-frame data are applied to the display panel 200. Thus, during the second sub-frame SF2 of the N-th frame FN, a green image is displayed on the display panel 200 by the data processing part 310 and the light-source part 400.

Third sub-frame data of the N-th frame FN include the blue pixel data corresponding to the first, second, third, fourth, fifth, sixth, seventh, eighth and ninth pixels 1, 2, 3, 4, 5, 6, 7, 8 and 9. The light-source part 400 emits the blue light during a third sub-frame SF3 of the N-th frame FN, during which the third sub-frame data are applied to the display panel 200. Thus, during the third sub-frame SF3 of the N-th frame FN, a blue image is displayed on the display panel 200 by the data processing part 310 and the light-source part 400.

Fourth sub-frame data of the N-th frame FN include the red pixel data corresponding to the second, third, fourth, sixth, seventh and eighth pixels 2, 3, 4, 6, 7 and 8, and the black pixel data corresponding to the first, fifth and ninth pixels 1, 5 and 9. The light-source part 400 emits the red light during a fourth sub-frame SF4 of the N-th frame FN, during which the fourth sub-frame data are applied to the display panel 200. Thus, during the fourth sub-frame SF4 of the N-th frame FN, the red image is displayed on the display panel 200 by the data processing part 310 and the light-source part 400.

Fifth sub-frame data of the N-th frame FN include the green pixel data corresponding to the third, fifth and seventh pixels 3, 5 and 7, and the black pixel data corresponding to the first, second, fourth, sixth, eighth and ninth pixels 1, 2, 4, 6, 8 and 9.

The light-source part 400 emits the green light during a fifth sub-frame SF5 of the N-th frame FN, during which the fifth sub-frame data are applied to the display panel 200. Thus, during the fifth sub-frame SF5 of the N-th frame FN, the green image is displayed on the display panel 200 by the data processing part 310 and the light-source part 400.

In an exemplary embodiment, the color sequence of the color images displayed by the data processing part 310 and the light-source part 400 during an (N+1)-th frame FN+1 is different from the color sequence of the color images displayed during the N-th frame FN.

In such an embodiment, the data processing part 310 generates first to fifth sub-frame data using (N+1)-th frame data.

First sub-frame data of the (N+1)-th frame FN+1 include the blue pixel data corresponding to the first, fifth and ninth pixels 1, 5 and 9 and black pixel data corresponding to the second, third, fourth, sixth, seventh and eighth pixels 2, 3, 4, 6, 7 and 8. The light-source part 400 emits the blue light during a first sub-frame SF1 of the (N+1)-th frame FN+1, during which the first sub-frame data are applied to the display panel 200.

Second sub-frame data of the (N+1)-th frame FN+1 include the red pixel data corresponding to the first, second, fourth, sixth, eighth and ninth pixels 1, 2, 4, 6, 8 and 9 and the black pixel data corresponding to the third, fifth and seventh pixels 3, 5 and 7. The light-source part 400 emits the red light during a second sub-frame SF1 of the (N+1)-th frame FN+1, during which the second sub-frame data are applied to the display panel 200.

Third sub-frame data of the (N+1)-th frame FN+1 include the green pixel data corresponding to the first, second, third, fourth, fifth, sixth, seventh, eighth and ninth pixels 1, 2, 3, 4, 5, 6, 7, 8 and 9. The light-source part 400 emits the green light during a third sub-frame SF3 of the (N+1)-th frame FN+1, during which the third sub-frame data are applied to the display panel 200.

Fourth sub-frame data of the (N+1)-th frame FN+1 include the blue pixel data corresponding to the second, third, fourth, sixth, seventh and eighth pixels 2, 3, 4, 6, 7 and 8, and the black pixel data corresponding to the first, fifth and ninth pixels 1, 5 and 9. The light-source part 400 emits the blue light during a fourth sub-frame SF4 of the (N+1)-th frame FN+1, during which the fourth sub-frame data are applied to the display panel 200.

Fifth sub-frame data of the (N+1)-th frame FN+1 include the red pixel data corresponding to the third, fifth and seventh pixels 3, 5 and 7, and the black pixel data corresponding to the first, second, fourth, sixth, eighth and ninth pixels 1, 2, 4, 6, 8 and 9. The light-source part 400 emits the red light during a fifth sub-frame SF5 of the (N+1)-th frame FN+1, during which the fifth sub-frame data are applied to the display panel 200.

In an exemplary embodiment, the color sequence of the color images displayed by the data processing part 310 and the light-source part 400 during an (N+2)-th frame FN+2 is different from the color sequence of the color images displayed during the (N+1)-th frame FN+1.

In such an embodiment, the data processing part 310 generates first to fifth sub-frame data using (N+2)-th frame data.

First sub-frame data of the (N+2)-th frame FN+2 include the green pixel data corresponding to the first, fifth and ninth pixels 1, 5 and 9 and the black pixel data corresponding to the second, third, fourth, sixth, seventh and eighth pixels 2, 3, 4, 6, 7 and 8. The light-source part 400 emits the green light during a first sub-frame SF1 of the (N+2)-th frame FN+2, during which the first sub-frame data are applied to the display panel 200.

Second sub-frame data of the (N+2)-th frame FN+2 include the blue pixel data corresponding to the first, second, fourth, sixth, eighth and ninth pixels 1, 2, 4, 6, 8 and 9 and the black pixel data corresponding to the third, fifth and seventh pixels 3, 5 and 7. The light-source part 400 emits the blue light during a second sub-frame SF2 of the (N+2)-th frame FN+2, during which the second sub-frame data are applied to the display panel 200.

Third sub-frame data of the (N+2)-th frame FN+2 include the red pixel data corresponding to the first, second, third, fourth, fifth, sixth, seventh, eighth and ninth pixels 1, 2, 3, 4, 5, 6, 7, 8 and 9. The light-source part 400 emits the red light during a third sub-frame SF3 of the (N+2)-th frame FN+2, during which the third sub-frame data are applied to the display panel 200.

Fourth sub-frame data of the (N+2)-th frame FN+2 include the green pixel data corresponding to the second, third, fourth, sixth, seventh and eighth pixels 2, 3, 4, 6, 7 and 8 and the black pixel data corresponding to the first, fifth and ninth pixels 1, 5 and 9. The light-source part 400 emits the green light during a fourth sub-frame SF4 of the (N+2)-th frame FN+2, during which the fourth sub-frame data are applied to the display panel 200.

Fifth sub-frame data of the (N+2)-th frame FN+2 include the blue pixel data corresponding to the third, fifth and seventh pixels 3, 5 and 7 and the black pixel data corresponding to the first, second, fourth, sixth, eighth and ninth pixels 1, 2, 4, 6, 8 and 9. The light-source part 400 emits the blue light during a fifth sub-frame SF5 of the (N+2)-th frame FN+2, during which the fifth sub-frame data are applied to the display panel 200.

Referring to the 3×3 pixel structure, the first and ninth pixels 1 and 9 have the color sequence such as the red, green, blue, black, black, blue, red, green black, black, green, blue, red, black and black during three consecutive frames, e.g., the N-th frame FN, the (N+1)-th frame FN+1 and the (N+2)-th frame FN+2. The fifth pixel 5 has the color sequence of the red, black, blue, black, green, blue, black, green, black, red, green, black, red, black and blue during the three consecutive frames FN, FN+1 and FN+2. The second, fourth, sixth and eighth pixels 2, 4, 6 and 8 have the color sequence of the black, green, blue, red, black, black, red, green, blue, black, black, blue, red, green and black during the three consecutive frames FN, FN+1 and FN+2. The third and seventh pixels 3 and 7 have the color sequence of the black, black, blue, red, green, black, black, green, blue, red, black, black, red, green and blue during the three consecutive frames FN, FN+1 and FN+2.

According to an exemplary embodiment, the color break-up is substantially reduced by a combination of colors displayed by at least three pixels in a vertical direction.

In an alternative exemplary embodiment, the data processing part 310 estimates a moving image in an entire frame image using an Motion Estimation and Motion Compensation (“MEMC”) and processes only the pixel data corresponding to the moving image using the method described referring to FIGS. 5 and 6. In such an embodiment, the color break-up at the edge area of the moving image is substantially reduced and power consumption is also substantially reduced.

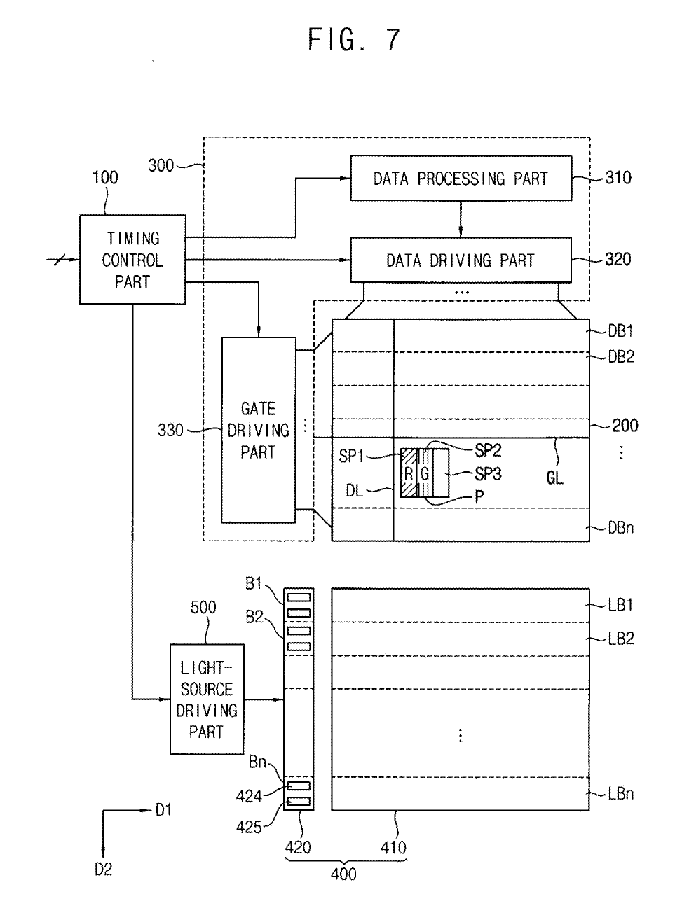

FIG. 7 is a block diagram illustrating an alternative exemplary embodiment of a display apparatus according to the invention.

Referring to FIG. 7, an exemplary embodiment of the display apparatus may include a timing control part 100, a display panel 200, a panel driving part 300, a light-source part 400 and a light-source driving part 500.

The timing control part 100 generates timing control signals using horizontal and vertical synchronization signals, and drives the display panel 200 and the light-source part 400 using the timing control signals

The display panel 200 may include a plurality of gate lines GL, a plurality of data lines DL and a plurality of pixels P. The gate lines GL extend substantially in a first direction D1 and arranged substantially in a second direction D2 crossing the first direction D1. The data lines DL extend substantially in the second direction D2 and arranged substantially in the first direction D1. Each of the pixels P includes a first sub-pixel SP1, a second sub-pixel SP2 and a third sub-pixel SP3. The first sub-pixel SP1 is a first color sub-pixel including a first color filter, the second sub-pixel SP2 is a second color sub-pixel including a second color filter, and the third sub-pixel SP3 is a transparent sub-pixel without a color filter. In an exemplary embodiment, as shown in FIG. 7, the first color filter may be a red color filter, and the second color filter may be a green color filter, but not being limited thereto. The colors of the first and second color filters may be preset variously.

The panel driving part 300 includes a data processing part 310, a data driving part 320 and a gate driving part 330.

The data processing part 310 generates first sub-frame data and second sub-frame data which include a mixed color pixel data (e.g., pixel data of a mixed color) and a primary color pixel (e.g., pixel data of a primary color) data using the frame data which include red, green and blue data. According to an exemplary embodiment, each sub-frame data include a plurality of data blocks. The data blocks adjacent to each other in the sub-frame data have color pixel data different from each other. Each of the data blocks in the sub-frame data has the color pixel data different from the color pixel data thereof in the next sub-frame data.

According to an exemplary embodiment, colors of the color pixel data includes a primary color among three primary colors, e.g., the red, green and blue, and a mixed color of the remaining two colors among three primary colors. In one exemplary embodiment, for example, the primary color may be the blue, and the mixed color may be yellow. In an alternative exemplary embodiment, the primary color may be the green, and the mixed color may be magenta. In another alternative exemplary embodiment, the primary color may be the red, and the mixed color may be cyan. According to an exemplary embodiment, three primary colors may be referred to as the red, green and blue, but not being limited thereto. Hereinafter, for convenience of description, an exemplary embodiment where the primary color is the blue, and the mixed color is the yellow, will now be described in detail.

According to an exemplary embodiment, a pixel P includes the first sub-pixel SP 1 having a red filter, a second sub-pixel SP2 having a green filter and a third sub-pixel SP3 that is a transparent sub-pixel. The pixel P receives blue pixel data to displays a blue image. The blue pixel data include black data applied to the first sub-pixel SP1, black data applied to the second sub-pixel SP2 and white data applied to the third sub-pixel SP3. The pixel P receives yellow pixel data to displays a yellow image. The yellow pixel data include modified red data Rm applied to the first sub-pixel SP1, modified green data Gm applied to the second sub-pixel SP2 and modified blue data Bm applied to the third sub-pixel SP3.

In one exemplary embodiment, for example, the modified red, green and blue data Rm, Gm and Bm are determined as the following Equation 1.

Rm: R−Min(R,G)

Gm: G−Min(R,G)

Bm: Min(R,G) Equation 1

In Equation 1, R, G and B denote grayscale data of red, green and blue input data, respectively.

The data driving part 320 converts the color pixel data received from the data processing part 310 into a data voltage, and outputs the data voltage to the data lines DL.

The data blocks of the sub-frame data are displayed on a plurality of display blocks DB1, DB2, . . . , DBn of the display panel 200, respectively. The display blocks DB1, DB2, . . . , DBn correspond to a plurality of light-emitting blocks LB1, LB2, . . . , LBn of the light-source part 400, respectively.

The gate driving part 330 generates a plurality of gate signals, and sequentially provides the gate lines GL with the gate signals, in synchronization with output timing of the data driving part 320.

The light-source part 400 includes an LGP 410 and light-source unit 420, which is disposed at an edge portion of the LGP and includes a plurality of color light-sources. The light-source unit 420 includes a plurality of light-source blocks B1, B2, . . . , Bn, and each of the light-source blocks includes a plurality of color light-sources 424 and 425. In an exemplary embodiment, the light-source block includes a yellow light-source 424 which emits yellow light, which is the mixed color light of two primary color lights, and a blue light-source 425 which emits blue light which is a primary color light.

The light-source part 400 is divided into the light-emitting blocks LB1, LB2, . . . , LBn corresponding to the light-source blocks B1, B2, . . . , Bn.

The light-source driving part 500 sequentially drives the light-source blocks B1, B2, . . . , Bn during a sub-frame of a frame. The light-source driving part 500 drives the yellow and blue light-sources 424 and 425 in each of the light-source blocks B1, B2, . . . , Bn, to emit color light corresponding to the color image displayed on the display block of display panel 200, based on a control of the timing control part 100.

In one exemplary embodiment, for example, during a first sub-frame of the frame period, yellow pixel data of a first data block are applied to a first display block DB1 of the display panel 200, a first light-emitting block LB1 of the light-source part 400 emits the yellow light corresponding to the yellow pixel data. As described above, the light-emitting block of the light-source part 400 emits the color light corresponding to the color pixel data applied to the display block of the display panel 200.

According to an exemplary embodiment, the display apparatus may display a first sub-frame image including color image blocks during the first sub-frame and display a second sub-frame image including color image blocks arranged different from the color image blocks of the first sub-frame image during the second sub-frame. In such an embodiment, the image blocks adjacent to each other have colors different from each other, and each of the image blocks has the color different from the color thereof in the next sub-frame. Thus, in an exemplary embodiment where the display apparatus operates in the temporal color display mode, the color break-up is substantially improved and a flicker caused by luminance difference between different colors is also substantially improved.

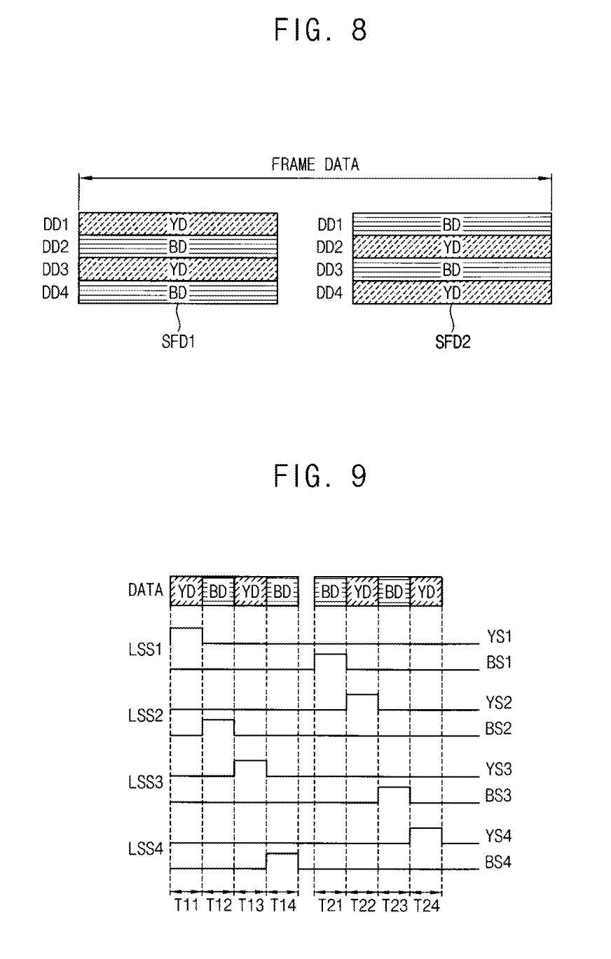

FIG. 8 is a conceptual diagram illustrating an exemplary embodiment of a method of driving a data processing part shown in FIG. 7.

Referring to FIGS. 7 and 8, according to an exemplary embodiment, the display panel 200 and the light-source part 400 may be driven at a driving frequency of about 120 Hz. Hereinafter, for convenience of description, an exemplary embodiment, where each of the display panel 200 and the light-source part 400 is divided into four blocks, will be described in detail.

The data processing part 310 generates a plurality of sub-frame data using the frame data. The frame data include red, green and blue data. The sub-frame data include first sub-frame data SFD1 and second sub-frame data SFD2, and each of the sub-frame data SFD1 and SFD2 include yellow pixel data YD and blue pixel data BD.

The first sub-frame data SFD1 include a first data block DD1 having the yellow pixel data YD, a second data block DD2 having the blue pixel data BD, a third data block DD3 having the yellow pixel data YD and a fourth data block DD4 having the blue pixel data BD.

The second sub-frame data SFD2 include the first data block DD1 having the blue pixel data BD, the second data block DD2 having the yellow pixel data YD, the third data block DD3 having the blue pixel data BD and the fourth data block DD4 having the yellow pixel data YD.

In such an embodiment, as described above, the data processing part 310 generates a plurality of sub-frame data, each sub-frame data include the data blocks adjacent to each other having color pixel data different from each other, and each of the data blocks in the sub-frame data has the color pixel data different from the color pixel data thereof in the next sub-frame data.

FIG. 9 is a signal timing diagram illustrating an exemplary embodiment of a method of displaying an image in the display apparatus shown in FIG. 7.

Referring to FIGS. 7, 8 and 9, the data driving part 320 provides the display panel 200 with the sub-frame data processed from the data processing part 310.

During the first sub-frame SF1 of the frame period F, the data driving part 320 provides the display panel 200 with the first sub-frame data SFD1. The light-source driving part 500 provides first to fourth light-source blocks B1, B2, B3 and B4 with first to fourth light-source driving signals LSS1, LSS2, LSS3 and LSS4 in synchronization with the first sub-frame data SFD1. Each of the light-source driving signals includes yellow and blue driving signals YS1, YS2, YS3 or YS4 and BS1, BS2, BS3 or BS4, which are applied to the yellow and blue light-sources 424 and 425.

In one exemplary embodiment, for example, during a first period T11 of the first sub-frame SF1, during which the yellow pixel data YD in the first data block DD1 of the first sub-frame data SFD1 are applied to a first display block DB1, the yellow light-source 424 of the first light-source block B1 turns on the light such that the first light-emitting block LB1 emits the yellow light (YS1). During the first period T11 of the first sub-frame SF1, the blue light-source 425 of the first light-source block B1 turn off the light (BS1).

During a second period T12 of the first sub-frame SF1, during which the blue pixel data BD in the second data block DD2 of the first sub-frame data SFD1 are applied to a second display block DB2, the blue light-source 425 of the second light-source block B2 turns on the light such that the second light-emitting block LB2 emits the blue light (BS2). During the second period T12 of the first sub-frame SF1, the yellow light-source 424 of the second light-source block B2 turn off the light (YS2).

During a third period T13 of the first sub-frame SF1, during which the yellow pixel data YD in the third data block DD3 of the first sub-frame data SFD1 are applied to a third display block DB3, the yellow light-source 424 of the third light-source block B3 turns on the light such that the third light-emitting block LB3 emits the yellow light (YS3). During the third period T13 of the first sub-frame SF1, the blue light-source 425 of the third light-source block B3 turn off the light (BS3).

During a fourth period T14 of the first sub-frame SF1, during which the blue pixel data BD in the fourth data block DD4 of the first sub-frame data SFD1 are applied to a fourth display block DB4, the blue light-source 425 of the fourth light-source block B4 turns on the light such that the fourth light-emitting block LB4 emits the blue light (BS4). During the fourth period T14 of the first sub-frame SF1, the yellow light-source 424 of the fourth light-source block B4 turn off the light (YS4).

During a second sub-frame SF2 of the frame F, the data driving part 320 provides the display panel 200 with the second sub-frame data SFD2. The light-source driving part 500 provides the first to fourth light-source blocks B1, B2, B3 and B4 with first to fourth light-source driving signals LSS1, LSS2, LSS3 and LSS4 in synchronization with second sub-frame data SFD2.

In one exemplary embodiment, for example, during a first period T21 of the second sub-frame SF2, during which the blue pixel data BD in the first data block DD1 of the second sub-frame data SFD2 are applied to the first display block DB1, the blue light-source 425 of the first light-source block B1 turns on the light such that the first light-emitting block LB1 emits the blue light (BS1). During the first period T21 of the second sub-frame SF2, the yellow light-source 424 of the first light-source block B1 turn off the light (YS1).

During a second period T22 of the second sub-frame SF2, during which the yellow pixel data YD in the second data block DD2 of the second sub-frame data SFD2 are applied to the second display block DB2, the yellow light-source 424 of the second light-source block B2 turns on the light such that the second light-emitting block LB2 emits the yellow light (YS2). During the second period T22 of the second sub-frame SF2, the blue light-source 425 of the second light-source block B2 turn off the light (BS2).

During a third period T23 of the second sub-frame SF2, during which the blue pixel data BD in the third data block DD3 of the second sub-frame data SFD2 are applied to the third display block DB3, the blue light-source 425 of the third light-source block B3 turns on the light such that the third light-emitting block LB3 emits the blue light (BS3). During the third period T23 of the second sub-frame SF2, the yellow light-source 424 of the third light-source block B3 turn off the light (YS3).

During a fourth period T24 of the second sub-frame SF2, during which the yellow pixel data YD in the fourth data block DD4 of the second sub-frame data SFD2 are applied to the fourth display block DB4, the yellow light-source 422 of the fourth light-source block B4 turns on the light such that the fourth light-emitting block LB4 emits the yellow light (YS4). During the fourth period T24 of the second sub-frame SF2, the blue light-source 425 of the fourth light-source block B4 turn off the light (BS4).

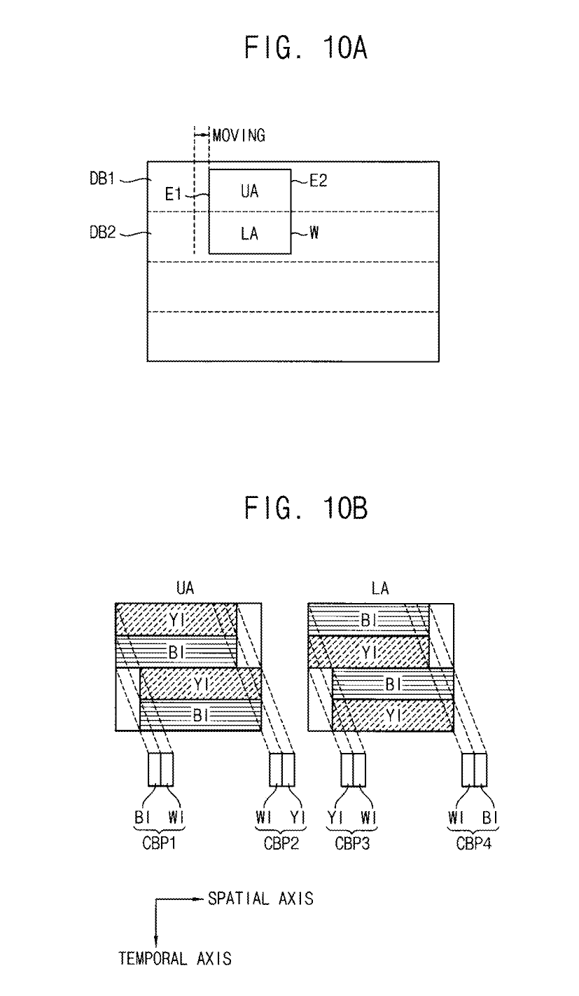

FIGS. 10A and 10B are conceptual diagrams illustrating a moving image displayed by the method shown in FIG. 9.

Referring to FIGS. 8, 10A and 10B, according to an exemplary embodiment, the display apparatus sequentially displays a yellow image and a blue image to display a white image during the frame period. In such an embodiment, color sequences of color images displayed on the display blocks adjacent to each other are different from each other.

Hereinafter, for convenience of description, an exemplary embodiment, in which a white box W is displayed on the first and second blocks DB1 and DB2, will be described in detail.

The first display block DB1 sequentially displays the yellow image YI and the blue image BI, and repetitively displays the yellow image YI and the blue image BI every frame.

The first display block DB1 displays an upper area UA of the white box W. The second display block DB2 sequentially displays the blue image BI and the yellow image YI, and repetitively displays the blue image BI and the yellow image YI every frame. The second display block DB2 displays a lower area LA of the white box W.

In an exemplary embodiment, the color images YI and BI are displayed in a time division mode. In such an embodiment, when the white box W moves along a temporal axis, a color breaking pattern may be generated at an edge area of the white box W.

Referring to FIG. 10B, a first color breaking pattern CBP1, which includes a white image WI by mixing the yellow image YI and the blue image BI, and the blue image BI, may be observed at a first edge area E1 of the upper area UA. A second color breaking pattern CBP2, which includes the white image WI by mixing the yellow image YI and the blue image BI, and the red image RI, may be observed at a second edge area E2 of the upper area UA.

A third color breaking pattern CBP3 which includes the white image WI by mixing the yellow image YI and the blue image BI, and the yellow image YI, may be observed at the first edge area E1 of the lower area LA. A fourth color breaking pattern CBP4 which includes the white image WI by mixing the yellow image YI and the blue image BI, and the blue image BI, may be observed at the second edge area E2 of the lower area LA.

As described above, according to an exemplary embodiment, various color breaking patterns CBP1, CBP2, CBP3 and CBP4 may be observed at the edge areas of the white box W. In such an embodiment, an achromatic color by mixing the color breaking CBP1, CBP2, CBP3 and CBP4 each other may be observed such that the color break-up observed at the edge areas of the moving image is substantially reduced.

According to an exemplary embodiment, when the number of the divided blocks of the display panel 200 and light-source part 400 is increased, the number of the color breaking pattern divided in the second direction D2 may be increased.

In such an embodiment, when a driving frequency of the display panel 200 and the light-source part 400 is increased, a width of the color breaking pattern in the first direction D1 may be decreased. In one exemplary embodiment, for example, according to the exemplary embodiment, the driving frequency of the display panel 200 and the light-source part 400 is about 120 Hz. In an alternative exemplary embodiment, where the driving frequency of the display panel 200 and the light-source part 400 is about 240 Hz, the width of the color breaking pattern in the first direction D1 may be decreased by about ½ with respect to the width of the color breaking pattern in the exemplary embodiment where the driving frequency of the display panel 200 and the light-source part 400 is about 120 Hz.

In an exemplary embodiment, as described above, when the number of the divided blocks of the display panel 200 and the light-source part 400 is increase and the driving frequency of the display panel 200 and the light-source part 400 is increased, the number of the color breaking pattern may be increased and the width of the color breaking pattern may be decreased. In such an embodiment, the color break-up observed at the edge areas of the moving image may be further reduced by increasing the number of the divided blocks or the driving frequency of the display panel 200 and the light-source part 400.

FIG. 11 is a conceptual diagram illustrating an alternative exemplary embodiment of a method of driving a data processing part according to the invention.

Referring to FIGS. 7 and 11, according to an exemplary embodiment, the display panel 200 and the light-source part 400 may be driven at the driving frequency of about 120 Hz. Hereinafter, for convenience of description, an exemplary embodiment where each of the display panel 200 and the light-source part 400 is divided into four blocks will be described in detail.

The data processing part 310 generates first sub-frame data SFD11 and second sub-frame data SFD12 using N-th frame data, which is applied during an N-th frame. Then, the data processing part 310 generates first sub-frame data SFD21 and second sub-frame data SFD22 using (N+1)-th frame data, which is applied during an (N+1)-th frame. The first sub-frame data SFD21 include a plurality of data blocks, which has a same color arrangement as the second sub-frame data SFD12, and the second sub-frame data SFD22 includes a plurality of data blocks, which has a same color arrangement as the first sub-frame data SFD11.

The first sub-frame data SFD11 corresponding to the N-th frame data include a first data block DD1 having the yellow pixel data YD, a second data block DD2 having the blue pixel data BD, a third data block DD3 having the yellow pixel data YD and a fourth data block DD4 having the blue pixel data BD.

The second sub-frame data SFD12 corresponding to the N-th frame data include the first data block DD1 having the blue pixel data BD, the second data block DD2 having the yellow pixel data YD, the third data block DD3 having the blue pixel data BD and the fourth data block DD4 having the yellow pixel data YD.

The first sub-frame data SFD21 corresponding to the (N+1)-th frame data include the first data block DD1 having the blue pixel data BD, the second data block DD2 having the yellow pixel data YD, the third data block DD3 having the blue pixel data BD and the fourth data block DD4 having the yellow pixel data YD.

The second sub-frame data SFD12 corresponding to the (N+1)-th frame data include the first data block DD1 having the yellow pixel data YD, the second data block DD2 having the blue pixel data BD, the third data block DD3 having the yellow pixel data YD and the fourth data block DD4 having the blue pixel data BD.

According to an exemplary embodiment, as shown in FIG. 11, during the N-th and (N+1)-th frames, the first and third data blocks have the color sequence of the yellow, blue, blue and yellow, and the second and fourth data blocks have the color sequence of the blue, yellow, yellow and blue.

An exemplary embodiment of a method of driving the display panel 200 and the light-source part 400 may be substantially similar to the method described in FIG. 9.

Referring to the N-th frame, during a first period, during which the yellow pixel data YD in the first data block DD1 of the first sub-frame data SFD11 are applied to a first display block DB1, the yellow light-source 424 of the first light-source block B1 turns on the light such that the first light-emitting block LB 1 emits the yellow light. During a second period, during which the blue pixel data BD in the second data block DD2 of the first sub-frame data SFD11 are applied to a second display block DB2, the blue light-source 425 of the second light-source block B2 turns on the light such that the second light-emitting block LB2 emits the blue light. During a third period, during which the yellow pixel data YD in the third data block DD3 of the first sub-frame data SFD11 are applied to a third display block DB3, the yellow light-source 424 of the third light-source block B3 turns on the light such that the third light-emitting block LB3 emits the yellow light. During a fourth period, during which the blue pixel data BD in the fourth data block DD4 of the first sub-frame data SFD11 are applied to a fourth display block DB4, the blue light-source 425 of the fourth light-source block B4 turns on the light such that the fourth light-emitting block LB4 emits the blue light.

Referring to the (N+1)-th frame, during a first period, during which the blue pixel data BD in the first data block DD1 of the second sub-frame data SFD12 are applied to a first display block DB1, the blue light-source 425 of the first light-source block B1 turns on the light such that the first light-emitting block LB 1 emits the blue light. During a second period, during which the yellow pixel data YD in the second data block DD2 of second sub-frame data SFD12 are applied to a second display block DB2, the yellow light-source 424 of the second light-source block B2 turns on the light such that the second light-emitting block LB2 emits the yellow light. During a third period, during which the blue pixel data BD in the third data block DD3 of the second sub-frame data SFD12 are applied to a third display block DB3, the blue light-source 425 of the third light-source block B3 turns on the light such that the third light-emitting block LB3 emits the blue light. During a fourth period, during which the yellow pixel data YD in the fourth data block DD4 of the second sub-frame data SFD12 are applied to a fourth display block DB4, the yellow light-source 424 of the fourth light-source block B4 turns on the light such that the fourth light-emitting block LB4 emits the yellow light.

In an exemplary embodiment, as described above, during the N-th and the (N+1)-th frames, each of the light-emitting blocks emits the color light respectively corresponding to the color pixel data applied to each of the display blocks.

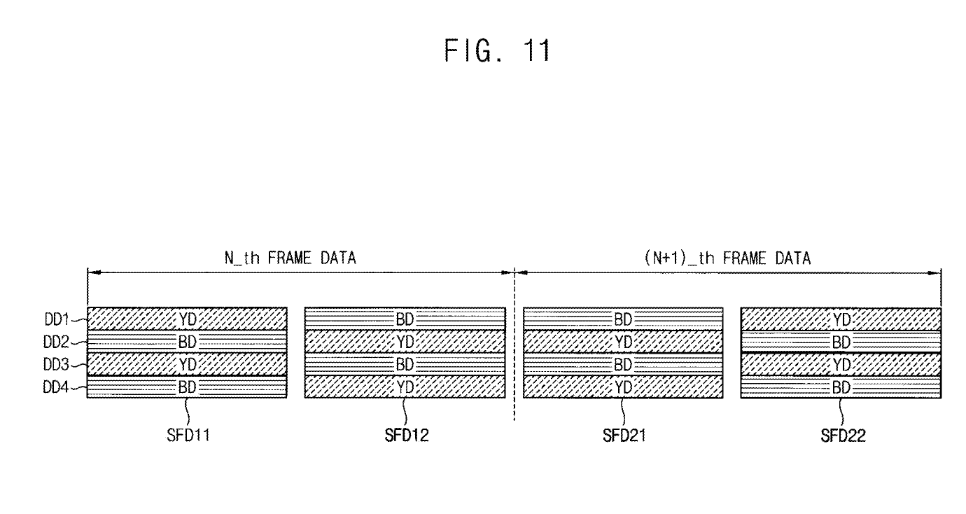

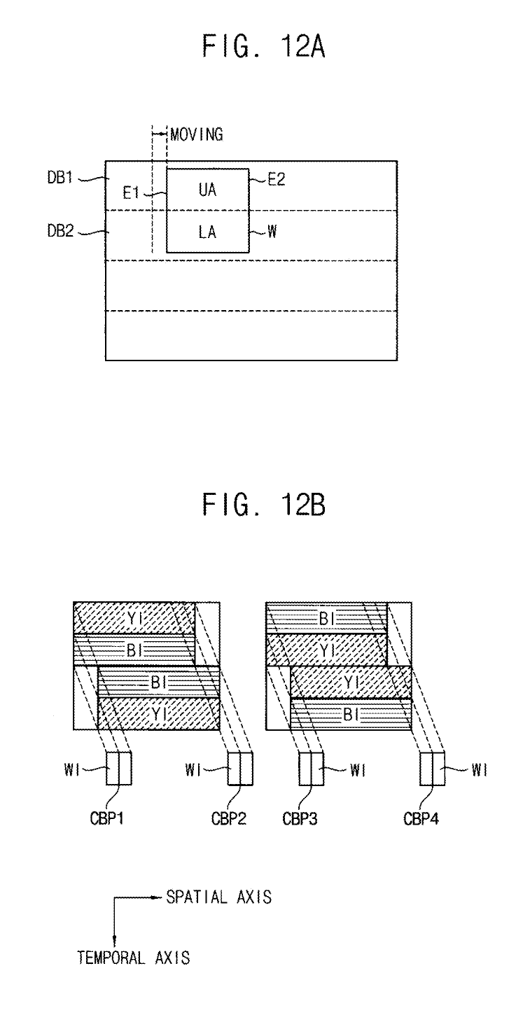

FIGS. 12A and 12B are conceptual diagrams illustrating a moving image displayed by the method shown in FIG. 11.

Referring to FIGS. 11, 12A and 12B, a white box W may be displayed on the first and second blocks DB1 and DB2.

The first display block DB1 sequentially displays the yellow image YI, the blue image BI, the blue image BI and the yellow image YI, and repetitively displays the yellow image YI, the blue image BI, the blue image BI and the yellow image YI every two frames. The first display block DB1 displays an upper area UA of the white box W. The second display block DB2 sequentially displays the blue image BI, the yellow image YI, the yellow image YI and the blue image BI, and repetitively displays the blue image BI, the yellow image YI, the yellow image YI and the blue image BI every two frames. The second display block DB2 displays a lower area LA of the white box W.

In an exemplary embodiment, the color images YI and BI are displayed in a time division mode. In such an embodiment, when the white box W moves along a temporal axis, a color breaking pattern may be generated at an edge area of the white box W.

Referring to FIG. 12B, a first color breaking pattern CBP1, which is a white image WI by mixing the yellow image YI and the blue image BI, may be observed at a first edge area E1 of the upper area UA. A second color breaking pattern CBP2, which is the white image MI1 by mixing the yellow image YI and the blue image BI, may be observed at a second edge area E2 of the upper area UA.

A third color breaking pattern CBP3, which is the white image WI by mixing the yellow image YI and the blue image BI, may be observed at the first edge area E1 of the lower area LA. A fourth color breaking pattern CBP4, which is the white image WI by mixing the yellow image YI and the blue image BI, may be observed at the second edge area E2 of the lower area LA.

In such an embodiment, as described above, the white image WI which is an achromatic color, may be observed at the edge areas of the white box W such that the color break-up observed at the edge areas of the moving image is substantially reduced.

According to an exemplary embodiment, when the number of the divided blocks of the display panel 200 and light-source part 400 is increased, the number of the color breaking pattern divided in the second direction D2 may be increased.

In such an embodiment, when a driving frequency of the display panel 200 and the light-source part 400 is increased, a width of the color breaking pattern in the first direction D1 may be decreased. In one exemplary embodiment, for example, the driving frequency of the display panel 200 and the light-source part 400 is about 120 Hz. In an alternative exemplary embodiment, where the driving frequency of the display panel 200 and the light-source part 400 is about 240 Hz, the width of the color breaking pattern in the first direction D1 may be decreased by about ½ with respect to the width of the color breaking pattern in an exemplary embodiment where the driving frequency of the display panel 200 and the light-source part 400 is about 120 Hz

In an exemplary embodiment, when the number of the divided blocks of the display panel 200 and the light-source part 400 is increase and the driving frequency of the display panel 200 and the light-source part 400 is increased, the number of the color breaking pattern may be increased and the width of the color breaking pattern may be decreased. In such an embodiment, the color break-up observed at the edge areas of the moving image may be further reduced by increasing the number of the divided blocks or the driving frequency of the display panel 200 and the light-source part 400.

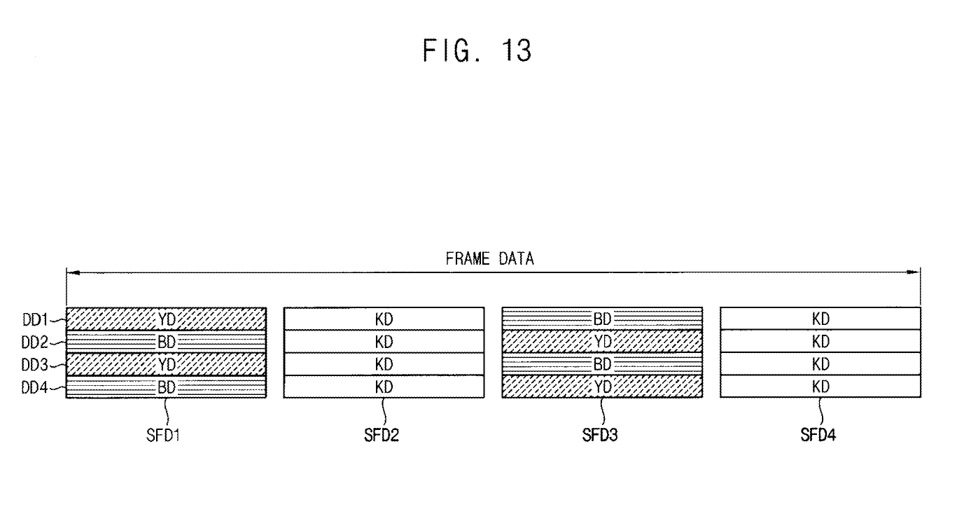

FIG. 13 is a conceptual diagram illustrating another alternative exemplary embodiment of a method of driving a data processing part according to the invention.

Referring to FIGS. 7 and 13, according to an exemplary embodiment, the display panel 200 and the light-source part 400 may be driven at the driving frequency of about 240 Hz.

The data processing part 310 generates a plurality of sub-frame data SFD1, SFD2, SFD3 and SFD4 using frame data including red, green and blue data. First sub-frame data SFD1 include yellow pixel data and blue pixel data. Second sub-frame data SFD2 include black pixel data. Third sub-frame data SFD3 include the yellow pixel data and the blue pixel data. Fourth sub-frame data SFD4 include the black pixel data.

The first sub-frame data SFD1 include a first data block DD1 having the yellow pixel data YD, a second data block DD2 having the blue pixel data BD, a third data block DD3 having the yellow pixel data YD and a fourth data block DD4 having the blue pixel data BD.

The second sub-frame data SFD2 are substantially black frame data having the black pixel data KD.

The third sub-frame data SFD3 include the first data block DD1 having the blue pixel data BD, the second data block DD2 having the yellow pixel data YD, the third data block DD3 having the blue pixel data BD and the fourth data block DD4 having the yellow pixel data YD.

The fourth sub-frame data SFD4 are substantially black frame data having the black pixel data KD.

According to an exemplary embodiment, as show in FIG. 13, during the frame period, the first and third data blocks have the color sequence such as the yellow, black, blue and black, and the second and fourth data blocks have the color sequence such as the blue, black, yellow and black.

According to an exemplary embodiment of a method of driving the display panel 200 and the light-source part 400, the light-emitting block emits the color light corresponding to the color pixel data applied to the display block, and the light-emitting block turns off the light when the black pixel data are applied to the display block.

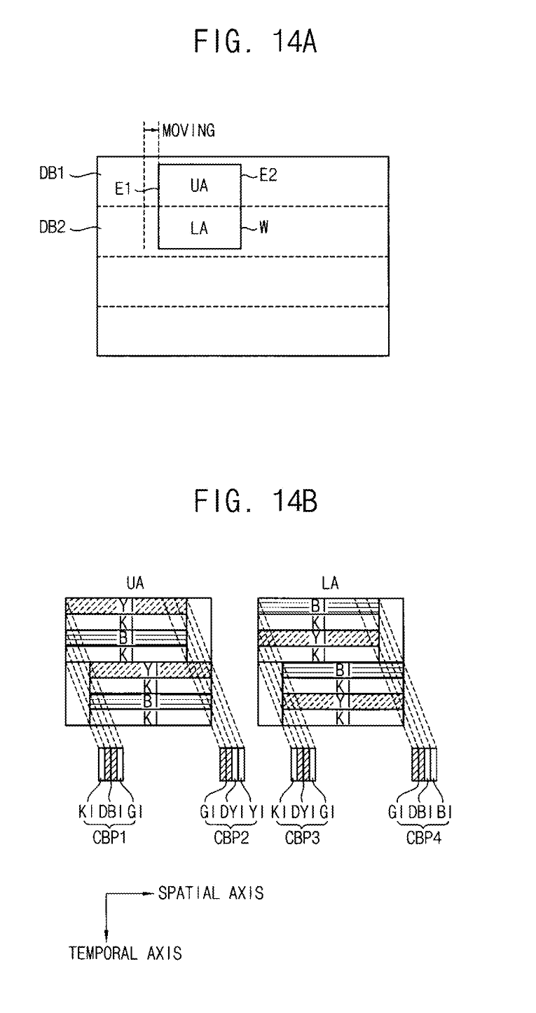

FIGS. 14A and 14B are conceptual diagrams illustrating a moving image displayed by the method shown in FIG. 13.

Referring to FIGS. 13, 14A and 14B, according to an exemplary embodiment, a white box W may be displayed on the first and second blocks DB1 and DB2.

The first display block DB1 sequentially displays the yellow image YI, the black image KI, the blue image BI and the black image KI, and repetitively displays the yellow image YI, the black image KI, the blue image BI and the black image KI every frame. The first display block DB1 displays an upper area UA of the white box W. The second display block DB2 sequentially displays the blue image BI, the black image KI, the yellow image YI and the black image KI, and repetitively displays the blue image BI, the black image KI, the yellow image YI every frame. The second display block DB2 displays a lower area LA of the white box W.

In an exemplary embodiment, the color images YI, BI and KI are displayed in a time division mode. In such an embodiment, when the white box W moves along a temporal axis, a color breaking pattern may be generated at an edge area of the white box W, as shown in FIG. 14B.

Referring to FIG. 14B, a first color breaking pattern CBP1, which includes a gray image GI by mixing the yellow image YI, the blue image BI and the black image KI, and a dark blue image DBI by mixing the blue image BI and the black image KI, and the black image KI, may be observed at a first edge area E1 of the upper area UA. A second color breaking pattern CBP2, which includes the yellow image YI, a dark yellow image DYI by mixing the yellow image YI and the black image KI, and the gray image GI by mixing the yellow image YI, the blue image BI and the black image KI, may be observed at a second edge area E2 of the upper area UA.

In such an embodiment, a third color breaking pattern CBP3, which includes the gray image GI, the dark yellow image DYI and the black image KI, may be observed at the first edge area E1 of the lower area LA. A fourth color breaking pattern CBP4, which includes the blue image BI, the dark blue image DBI and the gray image GI, may be observed at the second edge area E2 of the lower LA.

As described above, according to an exemplary embodiment, various color breaking patterns CBP1, CBP2, CBP3 and CBP4 may be observed at the edge areas of the white box W. In such an embodiment, an achromatic color by mixing the color breaking patterns CBP1, CBP2, CBP3 and CBP4 each other may be observed such that the color break-up observed at the edge areas of the moving image is substantially reduced.

According to an exemplary embodiment, when the number of the divided blocks of the display panel 200 and light-source part 400 is increased, the number of the color breaking pattern divided in the second direction D2 may be increased. In such an embodiment, the color break-up observed at the edge areas of the moving image may be further reduced when the number of the color breaking patterns is increased by increasing the number of the divided blocks or the driving frequency of the display panel 200 and the light-source part 400.

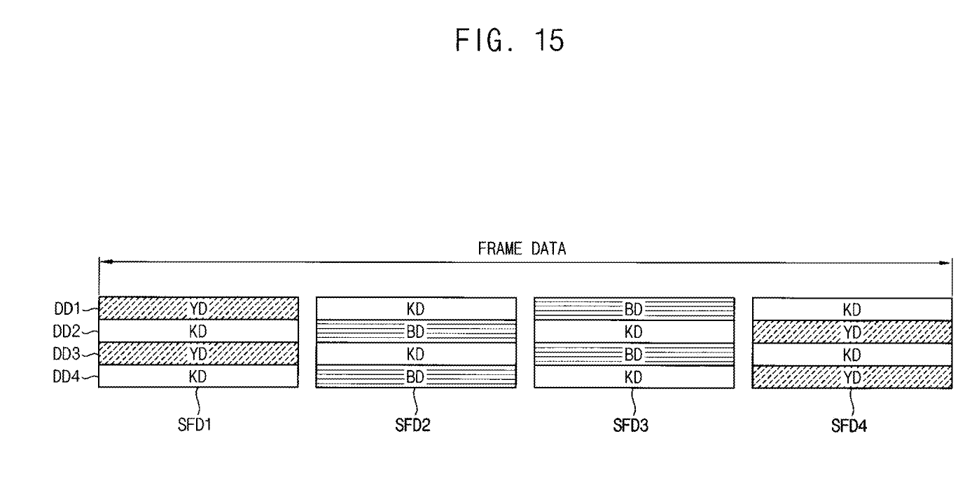

FIG. 15 is a conceptual diagram illustrating another alternative exemplary embodiment of a method of driving a data processing part according to the invention.

Referring to FIGS. 7 and 15, according to an exemplary embodiment, the display panel 200 and the light-source part 400 may be driven at the driving frequency of about 240 Hz.

The data processing part 310 generates first sub-frame data SFD1, second sub-frame data SFD2, third sub-frame data SFD3 and fourth sub-frame data SFD4 using frame data which include red, green and blue data.

The first sub-frame data SFD1 include a first data block DD1 having the yellow pixel data YD, a second data block DD2 having the black pixel data KD, a third data block DD3 having the yellow pixel data YD and a fourth data block DD4 having the black pixel data KD.

The second sub-frame data SFD2 include a first data block DD1 having the black pixel data KD, a second data block DD2 having the blue pixel data BD, a third data block DD3 having the black pixel data KD and a fourth data block DD4 having the blue pixel data BD.

The third sub-frame data SFD3 include a first data block DD1 having the blue pixel data BD, a second data block DD2 having the black pixel data KD, a third data block DD3 having the blue pixel data BD and a fourth data block DD4 having the black pixel data KD.

The fourth sub-frame data SFD4 include a first data block DD1 having the black pixel data KD, a second data block DD2 having the yellow pixel data YD, a third data block DD3 having the black pixel data KD and a fourth data block DD4 having the yellow pixel data YD.

According to an exemplary embodiment, as shown in FIG. 15, during the frame, the first and third data blocks have the color sequence of the yellow, black, blue and black, and the second and fourth data blocks have the color sequence of the black, blue, black and yellow.

According to an exemplary embodiment of a method of driving the display panel 200 and the light-source part 400, the light-emitting block emits the color light corresponding to the color pixel data applied to the display block. In such an embodiment, the light-emitting block turns off the light when the black pixel data are applied to the display block.

According to an exemplary embodiment, various color breaking patterns CBP1 to CBP4 may be observed at the edge areas of the white box W as shown in FIGS. 14A and 14B. In an exemplary embodiment, the color break-up observed at the edge areas of the moving image is substantially reduced by the various color breaking patterns.

According to an exemplary embodiment, when the number of the divided blocks of the display panel 200 and light-source part 400 is increased, the number of the color breaking pattern divided in the second direction D2 may be increased. In such an embodiment, the color break-up observed at the edge areas of the moving image may be further reduced when the number of the color breaking patterns is increased by increasing the number of the divided blocks or the driving frequency of the display panel 200 and the light-source part 400.

FIG. 16 is a conceptual diagram illustrating another alternative exemplary embodiment of a method of driving a data processing part according to the invention.

Referring to FIGS. 7 and 16, according to an exemplary embodiment, the display panel 200 and the light-source part 400 may be driven at the driving frequency of about 180 Hz.

According to an exemplary embodiment, the data processing part 310 generates three sub-frame data during the frame. The sub-frame data include 2×2 pixel data corresponding to a 2×2 pixel structure, which are repetitively arranged in the first direction D1 and the second direction D2. In the 2×2 pixel structure, first and second pixels 1 and 2 are sequentially arranged in the first direction D1. In the 2×2 pixel structure, third and fourth pixels 3 and 4 are sequentially arranged in the first direction D1, and disposed adjacent to the first and second pixels 1 and 2, respectively, in the second direction D2.

In such an embodiment, as shown in FIG. 16, the data processing part 310 generates first sub-frame data SFD1, second sub-frame data SFD2 and third sub-frame data SFD3 using frame data. Pixel data adjacent to each other in each of the first to third sub-frame data SFD1 to SFD3 have a color sequence different from each other.

In such an embodiment, each of the pixels 1, 2, 3 and 4 includes a first sub-pixel SP1, a second sub-pixel SP2 and a third sub-pixel SP3, which are arranged in the first direction D1 therein.

The first sub-frame data SFD1 include blue pixel data BD corresponding to the first and fourth pixels 1 and 4, which are arranged in a first diagonal direction, and black pixel data KD corresponding to the remaining second and third pixels 2 and 3. The blue pixel data BD include black grayscale data corresponding to the first sub-pixel SP1 and white grayscale data corresponding to the second sub-pixel SP2, which is a transparent sub-pixel. The black pixel data KD include back grayscale data respectively corresponding to the first, second and third sub-pixels SP1, SP2 and SP3.

The second sub-frame data SFD2 include the yellow pixel data YD respectively corresponding to first, second, third and fourth pixels 1, 2, 3 and 4. The yellow pixel data YD include the modified red data Rm corresponding to the first sub-pixel SP 1, the modified green data Gm corresponding to the second sub-pixel SP2 and the modified blue data Bm corresponding to the third sub-pixel SP3, as in Equation 1 described above.

The third sub-frame data SFD3 include the blue pixel data BD, respectively corresponding to second and third pixels 2 and 3 in a second diagonal direction crossing the first diagonal, and the black pixel data KD corresponding to the remaining first and fourth pixels 1 and 4.

According to an exemplary embodiment, the light-source part 400 emits the color light corresponding to the color pixel data during the sub-frame, during which the sub-frame data including the color pixel data are applied to the display panel 200.

In one exemplary embodiment, for example, during a first sub-frame, during which the first sub-frame data SFD1 including the blue pixel data BD are applied to the display panel 200, the light-source part 400 emits the blue light. During a second sub-frame, during which the second sub-frame data SFD2 including the yellow pixel data YD are applied to the display panel 200, the light-source part 400 emits the yellow light. During a third sub-frame, during which the third sub-frame data SFD3 including the blue pixel data BD are applied to the display panel 200, the light-source part 400 emits the blue light.

According to an exemplary embodiment, the light-source part 400 may be driven in a scanning mode, in which the light-source blocks of the light-source part 400 are sequentially turned on or off, as in the exemplary embodiment shown in FIG. 3. In an alternative exemplary embodiment, the light-source part 400 may be driven in a blinking mode, in which all of the light-source blocks of the light-source part 400 are simultaneously turned on or off.

According to an exemplary embodiment, the pixels adjacent to each other have color pixel data different from each other, and each of the pixels has the color pixel data different from the color pixel data thereof in the next sub-frame. In such an embodiment, where the display apparatus operates in the temporal color display mode, the color break-up is substantially improved and a flicker caused by luminance difference between different colors is also substantially improved, as in the exemplary embodiments described above.

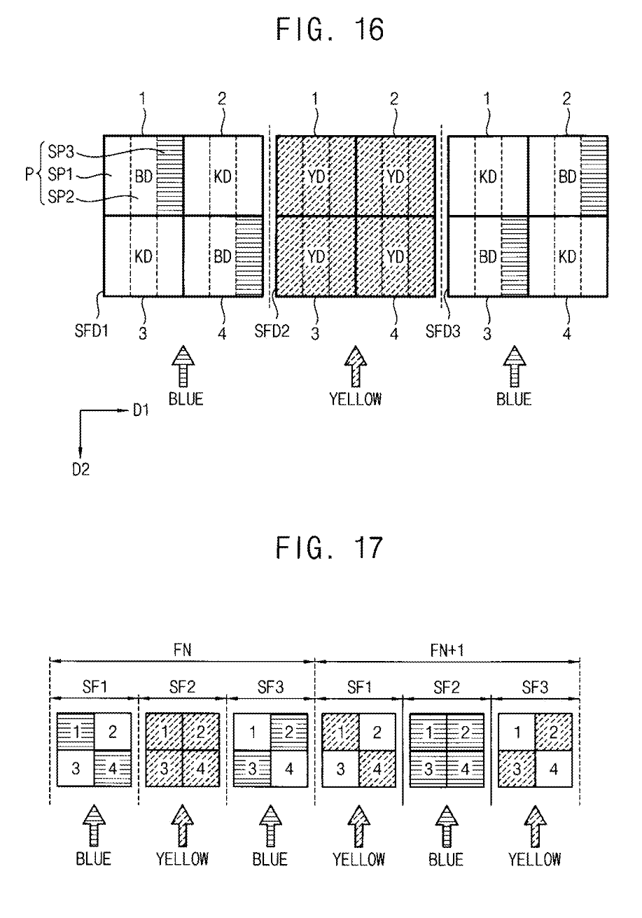

FIG. 17 is a conceptual diagram illustrating an exemplary embodiment of a method of displaying an image based on the method shown in FIG. 16.

Referring to FIGS. 7, 16 and 17, according to an exemplary embodiment, the display panel 200 sequentially displays three sub-frame images to display a white image during a frame period, and repetitively displays the same color image every two frames. The light-source part repetitively emits the same color light every two frames.

The data processing part 310 generates first to third sub-frame data using N-th frame data.

The first sub-frame data of the N-th frame FN include the blue pixel data BD corresponding to the first and fourth pixels 1 and 4, and the black pixel data KD corresponding to the second and third pixels 2 and 3. The light-source part 400 emits the blue light during the first sub-frame SF1 of the N-th frame FN, during which the first sub-frame data are applied to the display panel 200.

The second sub-frame data of the N-th frame FN include the yellow pixel data YD corresponding to the first, second, third and fourth pixels 1, 2, 3 and 4. The light-source part 400 emits the yellow light during the sub-frame SF2 of the N-th frame FN, during which the second sub-frame data are applied to the display panel 200.

The third sub-frame data of the N-th frame FN include the blue pixel data BD corresponding to the second and third pixels 2 and 3, and the black pixel data KD corresponding to the first and fourth pixels 1 and 4. The light-source part 400 emits the blue light during the third sub-frame SF3 of the N-th frame FN, during which the third sub-frame data are applied to the display panel 200.

The color sequence of the color images displayed by the data processing part 310 and the light-source part 400 during an (N+1)-th frame FN+1, is different from the color sequence of the color images displayed during the N-th frame FN.

The data processing part 310 generates first to third sub-frame data using (N+1)-th frame data.

The first sub-frame data of the (N+1)-th frame FN+1 include the yellow pixel data YD corresponding to the first and fourth pixels 1 and 4, and the black pixel data KD corresponding to the second and third pixels 2 and 3. The light-source part 400 emits the yellow light during the first sub-frame SF1 of the (N+1)-th frame FN+1, during which the first sub-frame data are applied to the display panel 200.

The second sub-frame data of the (N+1)-th frame FN+1 include the blue pixel data YD corresponding to the first, second, third and fourth pixels 1, 2, 3 and 4. The light-source part 400 emits the blue light during the sub-frame SF2 of the (N+1)-th frame FN+1, during which the second sub-frame data are applied to the display panel 200.

The third sub-frame data of the (N+1)-th frame FN+1 include the yellow pixel data YD corresponding to the second and third pixels 2 and 3, and the black pixel data KD corresponding to the first and fourth pixels 1 and 4. The light-source part 400 emits the yellow light during the third sub-frame SF3 of the (N+1)-th frame FN+1, during which the third sub-frame data are applied to the display panel 200.

Referring to the 2×2 pixel structure, the first and fourth pixels 1 and 4 may have the color sequence such as the blue, yellow, black, yellow, blue and black during a frames, e.g., the N-th frame FN and the (N+1)-th frame FN+1. The second and third pixels 2 and 3 may have the color sequence such as the black, yellow, blue, black, blue and yellow during the two frames.

According to an exemplary embodiment, the color break-up is substantially reduced by a combination of colors displayed by at least two pixels in a vertical direction.

In an alternative exemplary embodiment, the data processing part 310 estimates a moving image among an entire frame image using the MEMC and processes only the pixel data included in the moving image using the method as described referring to FIGS. 16 and 17. In such an embodiment, the color break-up generated at the edge area of the moving image and power consumption are substantially reduced.

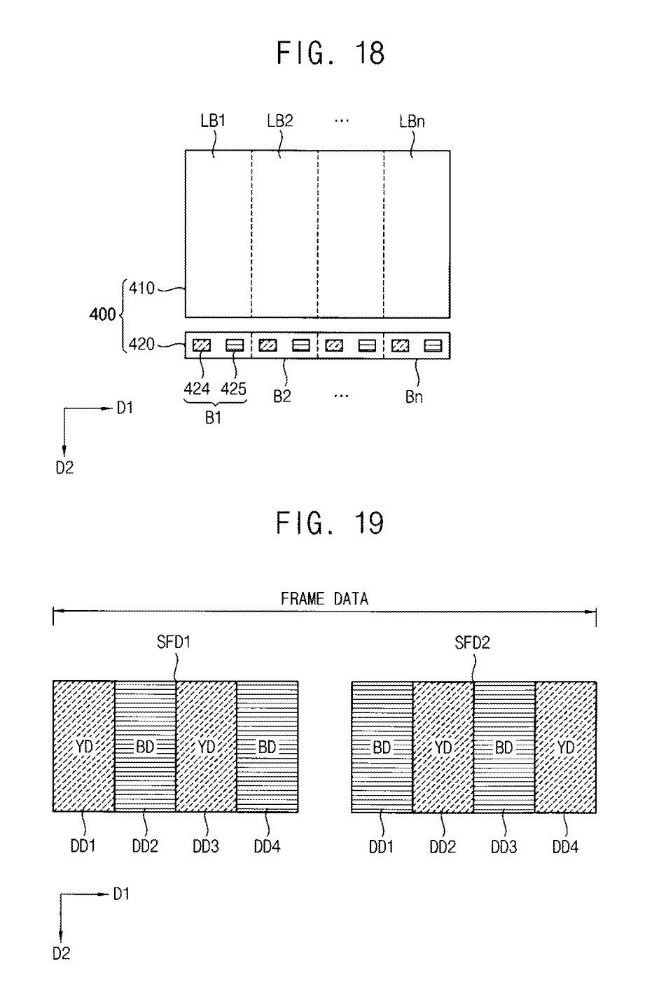

FIG. 18 is a conceptual diagram illustrating an exemplary embodiment of a light-source part of a display apparatus according to the invention. FIG. 19 is a conceptual diagram illustrating an exemplary embodiment of a method of driving the display apparatus shown in FIG. 18.

Referring to FIGS. 7, 18 and 19, according to an exemplary embodiment, the display apparatus includes a light-source part 400. The light-source part 400 includes an LGP 410 and a light-source unit 420 disposed at a longer-side of the LGP 410. The light-source unit 420 includes a plurality of light-source blocks B1, B2, . . . , Bn. Each of the light-source blocks B1, B2, . . . , Bn includes a mixed color light-source 424 and a primary color light-source 425. The mixed color light-source 424 emits mixed color light corresponding to a mixed color of primary colors among three primary colors including red, green and blue.

The primary color light-source 425 emits color light corresponding to the remaining primary color among the three primary colors. Hereinafter, for convenience of description, an exemplary embodiment where the mixed color light-source 424 is a yellow light-source that emits yellow light and the primary color light-source 425 is a blue light-source that emits blue light, will be described in detail.

The light-source part 400 is divided into a plurality of light-emitting blocks LB1, LB2, . . . , LBn based on the light-source blocks B1, B2, . . . , Bn. Each of the light-emitting blocks emits the color light corresponding to a color image displayed on the display block.

According to an exemplary embodiment, the display panel 200 and the light-source part 400 may be driven at a driving frequency of about 120 Hz. The display panel 200 may be divided into a plurality of data blocks DD1, DD2, . . . , DDn corresponding to the light-emitting blocks LB1, LB2, . . . , LBn, respectively, in the first direction D1 (e.g., a longitudinal direction) of the display panel 200.

In an exemplary embodiment, each of the display panel 200 and the light-source part 400 may be divided into four blocks, as shown in FIG. 19.

The data processing part 310 generates first sub-frame data SFD1 and second sub-frame data SFD2 using frame data including red, green and blue data. The first and second sub-frame data SFD1 and SFD2 include yellow pixel data YD and blue pixel data BD.

The first sub-frame data SFD1 include a first data block DD1 having the yellow pixel data YD, a second data block DD2 having the blue pixel data BD, a third data block DD3 having the yellow pixel data YD and a fourth data block DD4 having the blue pixel data BD.

The second sub-frame data SFD2 include the first data block DD1 having the blue pixel data BD, the second data block DD2 having the yellow pixel data YD, the third data block DD3 having the blue pixel data BD and the fourth data block DD4 having the yellow pixel data YD.

In such an embodiment, as described above, the data processing part 310 generates a plurality of sub-frame data, each of the sub-frame data include the data blocks adjacent to each other having color pixel data different from each other, and each of the data blocks in the sub-frame data has the color pixel data different from the color pixel data thereof in the next sub-frame data.

According to an exemplary embodiment, during the first sub-frame, during which the first sub-frame data SFD1 are applied to the display panel 200, the first light-source block B1 emits the yellow light corresponding to the yellow pixel data YD applied to the first data block DD1, the second light-source block B2 emits the blue light corresponding to the blue pixel data BD applied to the second data block DD2, the third light-source block B3 emits the yellow light corresponding to the yellow pixel data YD applied to the third data block DD3 and the fourth light-source block B4 emits the blue light corresponding to the blue pixel data BD applied to the fourth data block DD4.

In such an embodiment, during the first sub-frame, during which the second sub-frame data SFD2 are applied to the display panel 200, the first light-source block B1 emits the blue light corresponding to the blue pixel data BD applied to the first data block DD1, the second light-source block B2 emits the yellow light corresponding to the yellow pixel data YD applied to the second data block DD2, the third light-source block B3 emits the blue light corresponding to the blue pixel data BD applied to the third data block DD3 and the fourth light-source block B4 emits the yellow light corresponding to the yellow pixel data YD applied to the fourth data block DD4.

According an exemplary embodiment, the data blocks are arranged in the longer-side direction of the display panel, the data blocks adjacent to each other have color pixel data different from each other, and each of the data blocks has the color pixel data different from the color pixel data thereof in the next sub-frame. In such an embodiment, the color break-up observed at the edge areas of the moving image is substantially reduced as in the exemplary embodiments described above.

In an alternative exemplary embodiment, the light-source unit may include the red, green and blue light-sources as in the exemplary embodiment shown in FIG. 1 and be disposed at the longer-side of the display panel. In such an embodiment, the image blocks adjacent to each other in the longer-side direction have color pixel data different from each other, and each of the image blocks has the color pixel data different from the color pixel data thereof in the next sub-frame. In such an embodiment, the color break-up observed at the edge areas of the moving image are also substantially reduced as in the exemplary embodiments described above.

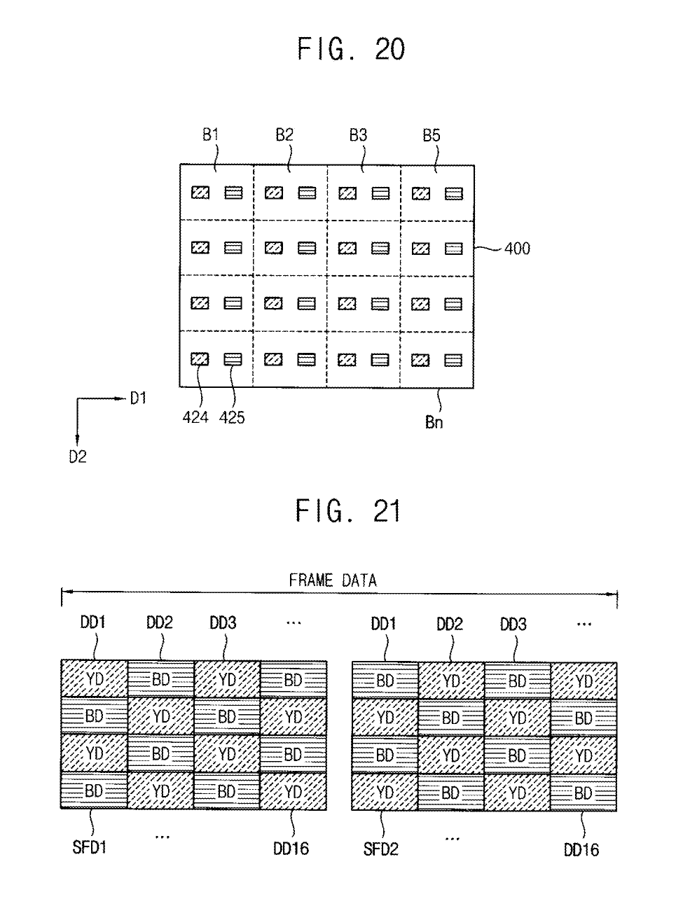

FIG. 20 is a conceptual diagram illustrating an alternative exemplary embodiment of a light-source part of a display apparatus according to the invention. FIG. 21 is a conceptual diagram illustrating an exemplary embodiment of a method of driving the display apparatus shown in FIG. 20.

Referring to FIGS. 7, 20 and 21, according to an exemplary embodiment, the display apparatus includes a light-source part 400. In an exemplary embodiment, as shown in FIG. 20, the light-source part 400 is directly disposed under the display panel 200 (e.g., a direct-illumination type) and includes a plurality of light-source blocks B1, B2, . . . , Bn arranged in the first direction D1 and the second direction D2, which may be arranged substantially in a matrix form. Each of the light-source blocks B1, B2, . . . , Bn includes a plurality of color light-sources 424 and 425. The color light-sources 424 and 425 of each of the light-source blocks B1, B2, . . . , Bn include a mixed color light-source 424 and a primary color light-source 425. The mixed color light-source 424 emits color light corresponding to a mixed color of two primary colors among three primary colors such as the red, green and blue. The primary color light-source 425 emits color light corresponding to the remaining color among the three primary colors. Hereinafter, an exemplary embodiment where the mixed color light-source 424 is a yellow light-source that emits yellow light and the primary color light-source 425 is a blue light-source that emits blue light, will be described in detail.

The light-source part 400 is divided into a plurality of light-emitting blocks LB1, LB2, . . . , LBn corresponding to the light-source blocks B1, B2, . . . , Bn. Each of the light-emitting blocks B1, B2, . . . , Bn emits the color light corresponding to color pixel data applied to the display block in the display panel 200.

According to an exemplary embodiment, the display panel 200 and the light-source part 400 may be driven at the driving frequency of about 120 Hz. The display panel 200 displays a plurality of data blocks DD1, DD2, . . . , DDn respectively corresponding to the light-emitting blocks LB1, LB2, . . . , LBn arranged substantially in a matrix form. As shown in FIG. 21, in one exemplary embodiment, for example, each of the display panel 200 and the light-source part 400 may be divided into 16 blocks arranged in a matrix form, which includes four block columns and four block rows.

The data processing part 310 generates first sub-frame data SFD1 and second sub-frame data SFD2 using frame data including red, green and blue data. Each of the first and second sub-frame data SFD1 and SFD2 include yellow pixel data YD and blue pixel data BD.

The first sub-frame data SFD1 include the data blocks including the yellow pixel data YD and the data blocks including the blue pixel data BD, and the data blocks adjacent in the first sub-frame data SFD1 to each other including the color pixel data different from each other.

The second sub-frame data SFD2 include the data blocks including the yellow pixel data YD and the data blocks including the blue pixel data BD. The data blocks adjacent to each other in the second sub-frame data SFD2 include the color pixel data different from each other. The data blocks of the second sub-frame data SFD2 include the color pixel data opposite to the data blocks of the first sub-frame data SFD1.

In one exemplary embodiment, for example, a first data block DD1 of the first sub-frame data SFD1 includes the yellow pixel data YD, and a second data block DD2 of the first sub-frame data SFD1 includes the blue pixel data BD. In such an embodiment, the first data block DD1 of the second sub-frame data SFD2 includes the blue pixel data BD, and the second data block DD2 of the second sub-frame data SFD2 includes the yellow pixel data YD.

According to an exemplary embodiment of the method of driving the display apparatus, during a period, during which the first sub-frame data SFD1 are applied to the display panel 200, a first light-source block B1 emits the yellow light corresponding to the yellow pixel data YD of the first data block DD1, and a second light-source block B2 emits the blue light corresponding to the blue pixel data BD of the second data block DD2. In such an embodiment, as described above, the remaining light-source blocks respectively emit color light corresponding to the color pixel data of the corresponded data block.

Then, during a period, during which the second sub-frame data SFD2 are applied to the display panel 200, the first light-source block B1 emits the blue light corresponding to the blue pixel data BD of the first data block DD1, and first the second light-source block B2 emits the yellow light corresponding to the yellow pixel data YD of the second data block DD2. As described above, the remaining light-source blocks respectively emit color light corresponding to the color pixel data of the corresponded data block.

According an exemplary embodiment, the data blocks are arranged substantially in a matrix form, the data blocks adjacent to each other have the color pixel data different from each other, and each of the data blocks has the color pixel data different from the color pixel data thereof in the next sub-frame. In such an embodiment, the color break-up observed at the edge areas of the moving image is substantially reduced, as in the exemplary embodiments described above.

In an alternative exemplary embodiment, the light-source block may include the red, green and blue light-sources, as in the exemplary embodiment shown in FIG. 1, and be directly disposed under the display panel as the direct-illumination type. In such an embodiment, the data blocks are arranged substantially in a matrix form, the data blocks adjacent to each other have the color pixel data different from each other, and each of the data blocks has the color pixel data different from the color pixel data thereof in the next sub-frame. In such an embodiment, the color break-up observed at the edge areas of the moving image is substantially reduced, as in the exemplary embodiments described above.

According to exemplary embodiments of the invention, block images adjacent to each other in a frame image have color different from each other, and each of the block images has the color different from the color pixel data thereof in the next sub-frame, such that the color break-up observed at the edge areas of the moving image and the flicker caused by luminance difference between different colors are substantially reduced.

The foregoing is illustrative of the invention and is not to be construed as limiting thereof. Although a few exemplary embodiments of the invention include been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A display apparatus comprising:
a display panel which displays an image, wherein the display panel comprises a plurality of display blocks;
a panel driving part which provides the display panel with a first sub-frame data during a first sub-frame of an N-th frame, provides the display panel with a second sub-frame data during a second sub-frame of the N-th frame, and provides the display panel with a third sub-frame data during a third sub-frame of the N-th frame, wherein
the first sub-frame data comprises a plurality of data blocks, the data blocks adjacent to each other in the first sub-frame data have color pixel data different from each other,
the second sub-frame data comprises a plurality of data blocks having a color sequence different from a color sequence of the data blocks of the first sub-frame data, and
the third sub-frame data comprises a plurality of data blocks having a color sequence different from the color sequence of the first sub-frame data and the color sequence of the second sub-frame data, and N is a natural number; and
a light-source part which provides the display blocks with color light corresponding to color pixel data applied to the display blocks.

2. The display apparatus of claim 1, wherein
the first sub-frame data comprises a first data block having a first color pixel data, a second data block having second a color pixel data and a third data block having a third color pixel data,
the second sub-frame data comprises a first data block having the second color pixel data, a second data block having the third color pixel data, a third data block having the first color pixel data,
the third sub-frame data comprises a first data block having the third color pixel data, a second data block having the first color pixel data, a third data block having the second color pixel data, and
a mixed color of the first, second and third colors is white.

3. The display apparatus of claim 2, wherein
during the first sub-frame, the light-source part provides a first display block of the display blocks, which receives the first color pixel data, with a first color light, provides a second display block of the display blocks, which receives the second color pixel data, with a second color light, and provides a third display block of the display blocks, which receives the third color pixel data, with a third color light,
during the second sub-frame, the light-source part provides the first display block, which receives the second color pixel data, with the second color light, provides the second display block, which receives the third color pixel data, with the third color light, and provides the third display block, which receives the first color pixel, data with the first color light, and
during the third sub-frame, the light-source part provides the first display block, which receives the third color pixel data, with the third color light, provides the second display block, which receives the first color pixel data, with the first color light, and provides the third display block, which receives the second color pixel, data with the second color light.

4. A display apparatus comprising:
a display panel which displays an image, wherein the display panel comprises a plurality of display blocks;
a panel driving part which provides the display panel with a first sub-frame data during a first sub-frame of an N-th frame and provides the display panel with a second sub-frame data during a second sub-frame of the N-th frame, wherein
the first sub-frame data comprise a plurality of data blocks, the data blocks adjacent to each other have color pixel data different from each other, and
the second sub-frame data comprise a plurality of data blocks having a color sequence different from a color sequence of the data blocks of the first sub-frame data, and N is a natural number; and
a light-source part which provides the display blocks with color light corresponding to color pixel data applied to the display blocks.

5. The display apparatus of claim 4, wherein
the first sub-frame data comprises a first data block having a mixed color pixel data and a second data block having a primary color pixel data,
the second sub-frame data comprises a first data block having the primary color pixel data and a second data block having the mixed color pixel data,
the mixed color is a mixed color of two primary colors of three primary colors,
the primary color is the remaining primary color of the three primary colors, and
a mixed color of the three primary colors is white.

6. The display apparatus of claim 5, wherein
during the first sub-frame, the light-source part provides a first display block of the display blocks, which receives the mixed color pixel data, with a mixed color light and provides a second display block of the display blocks, which receives the primary color pixel data, with a primary color light, and
during the second sub-frame, the light-source part provides the first display block, which receives the primary color pixel data, with the primary color light and provides the second display block, which receives the mixed color pixel data, with the mixed color light.

7. The display apparatus of claim 4, wherein
during a first sub-frame of an (N+1)-th frame, the panel driving part provides the display panel with a third sub-frame data comprising a plurality of data blocks having a color sequence the same as the color sequence of the data blocks of the second sub-frame data, and
during a second of the (N+1)-th frame, the panel driving part provides the display panel with a fourth sub-frame data comprising a plurality of data blocks having a color sequence the same as the color sequence of the data blocks of the first sub-frame data.

8. The display apparatus of claim 4, wherein
the panel driving part provides the display panel with black frame data during a third sub-frame of the N-th frame, wherein the third sub-frame of the N-th frame is between the first sub-frame and the second sub-frame of the N-th frame, and
the panel driving part provides the display panel with the black frame data during a fourth sub-frame of the N-th frame.

9. The display apparatus of claim 4, wherein
the first sub-frame data comprises a first data block having a first color pixel data and a second data block having black pixel data,
during the second sub-frame of the N-th frame, the panel driving part provides the display panel with the second sub-frame data comprising a first data block having the black pixel data and a second data block having a second color pixel data,
during a third sub-frame of the N-th frame, the panel driving part provides the display panel with a third sub-frame data comprising a first data block having the second color pixel data and a second data block having the black pixel data, and
during a fourth sub-frame of the N-th frame, the panel driving part provides the display panel with a fourth sub-frame data comprising a first data block having the black pixel data and a second data block having the first color pixel data.

10. The display apparatus of claim 4, wherein the light-source part is disposed at a shorter-side of the display panel.

11. The display apparatus of claim 4, wherein the light-source part is disposed at a longer-side of the display panel.

12. The display apparatus of claim 4, wherein the light-source part is disposed under the display panel.

13. A display apparatus comprising:
a display panel which displays an image;
a panel driving part which generates a sub-frame data comprising M×M pixel data, wherein M is a natural number, and the M×M pixel data of the sub-frame data have a color sequence different from a color sequence of the M×M pixel data of a next sub-frame data; and
a light-source part which provides the display panel with color light corresponding to colors of pixel data applied to the display panel.

14. The display apparatus of claim 13, wherein a pixel data of the M×M pixel data is black pixel data.

15. The display apparatus of claim 13, wherein the sub-frame data comprises 3×3 pixel data, which are repetitively arranged therein.

16. The display apparatus of claim 15, wherein
the panel driving part provides the display panel with a first sub-frame data comprising 3×3 pixel data during a first sub-frame of a frame period, wherein three pixel data of the 3×3 pixel data of the first sub-frame data are first color pixel data and arranged in a first diagonal direction with respect to a 3×3 structure, and remaining six pixel data of the 3×3 pixel data of the first sub-frame data are black pixel data,
the panel driving part provides the display panel with a second sub-frame data comprising 3×3 pixel data during a second sub-frame of the frame period, wherein three pixel data of the 3×3 pixel data of the second sub-frame data are the black pixel data and arranged in a second diagonal direction crossing the first diagonal direction with respect to the 3×3 structure, and remaining six pixel data of the 3×3 pixel data of the second sub-frame data are second color pixel data of the second sub-frame data,
the panel driving part provides the display panel with a third sub-frame data comprising 3×3 pixel data during a third sub-frame of the frame period, wherein the 3×3 pixel data of the third sub-frame data are third color pixel data,
the panel driving part provides the display panel with a fourth sub-frame data comprising 3×3 pixel data during a fourth sub-frame of the frame period, wherein three pixel data of the 3×3 pixel data of the fourth sub-frame data are the black pixel data and arranged in the first diagonal direction with respect to the 3×3 structure, and remaining six pixel data of the 3×3 pixel data of the fourth sub-frame data are the first color pixel data, and
the panel driving part provides the display panel with fifth sub-frame data comprising 3×3 pixel data during a fifth sub-frame of the frame period, wherein three pixel data of the 3×3 pixel data of the fifth sub-frame data are the second color pixel data and arranged in the second diagonal direction with respect to the 3×3 structure, and remaining six pixel data of the 3×3 pixel data of the fifth sub-frame data are the black pixel data.

17. The display apparatus of claim 16, wherein
the light-source part provides the display panel with a first color light during the first sub-frame,
the light-source part provides the display panel with a second color light during the second sub-frame,
the light-source part provides the display panel with a third color light during the third sub-frame,
the light-source part provides the display panel with the first color light during the fourth sub-frame, and
the light-source part provides the display panel with the second color light during the fourth sub-frame.

18. The display apparatus of claim 13, wherein the sub-frame data comprises 2×2 pixel data, which are repetitively arranged therein.

19. The display apparatus of claim 18, wherein
the panel driving part provides the display panel with a first sub-frame data comprising 2×2 pixel data during a first sub-frame of a frame period, wherein two pixel data of the 2×2 pixel data of the first sub-frame data are first color pixel data and arranged in a first diagonal direction with respect to a 2×2 structure, and remaining two pixel data of the 2×2 pixel data of the first sub-frame data are black pixel data,
the panel driving part provides the display panel with a second sub-frame data comprising 2×2 pixel data during a second sub-frame of the frame period, wherein the 2×2 pixel data of the second sub-frame data are second color pixel data, and
the panel driving part provides the display panel with a third sub-frame data comprising 2×2 pixel data during a third sub-frame of the frame period, wherein two pixel data of the 2×2 pixel data of the third sub-frame data are the first color pixel data and arranged in a second diagonal direction crossing the first diagonal direction with respect to the 2×2 structure, and remaining two pixel data of the 2×2 pixel data of the third sub-frame data are the black pixel data.

20. The display apparatus of claim 19, wherein
the light-source part provides the display panel with a first color light during the second sub-frame, and
the light-source part provides the display panel with a second color light during the second sub-frame,
wherein the first color is a mixed color of two primary colors of three primary colors, and
the second color is the remaining primary color of the three primary colors.
